(19) United States
(12) Patent Application Publication
(10) Pub. No.: US 2020/0383343 A1
(43) Pub. Date: Dec. 10, 2020

(54) METHOD OF PROTECTING ITEMS FROM DEGRADATION AND DECOMPOSITION

(71) Applicant: Apeel Technology, Inc., Goleta, CA (US)

(72) Inventors: Gabriel Rodriguez, Goleta, CA (US); Daniel Ross, Santa Barbara, CA (US)

(21) Appl. No.: 16/893,096

(22) Filed: Jun. 4, 2020

Related U.S. Application Data
(60) Provisional application No. 62/857,207, filed on Jun. 4, 2019.

(51) Int. Cl. A23B 7/16; B05D 7/24; B05D 7/00; A23B 7/154; A23P 20/15

(52) U.S. Cl. CPC A23B 7/16; B05D 7/24; A23P 20/15; A23B 7/154; B05D 7/534

(57) ABSTRACT

Methods of forming a protective coating on a surface of one or more substrates. The methods include providing a mixture including a coating agent in a solvent, forming a fog from the mixture, allowing the fog to contact the outer surface of the one or more substrates so that a portion of the mixture accumulates on at least a portion of the surface of the one or more substrates. The solvent from the mixture is then at least partially removed from the surface of the one or more substrates, e.g., by evaporation or forced convection, causing a protective coating to be formed from the coating agent on at least a part of the surfaces of the one or more substrates. The protective coating can, for example, protect at least to some extent the substrates from biotic or abiotic stressors such as mass or moisture loss, oxidation, mold, fungi, or infestation.

### RELATED APPLICATIONS

This application claims the benefit under 35 U.S.C. § 119(e) of U.S. Provisional Patent Application No. 62/857,207, filed Jun. 4, 2019, the disclosure of which is incorporated herein by reference in its entirety.

### TECHNICAL FIELD

The present disclosure relates to methods of treating produce, agricultural products, and other perishable items in order to reduce spoilage rates and extend their shelf lives.

### BACKGROUND

Common agricultural products such as plants and fresh produce are highly susceptible to degradation and decomposition (i.e., spoilage) when exposed to the environment. The degradation of the agricultural products can occur, for example, via abiotic means as a result of evaporative moisture loss from an external surface of the agricultural products to the atmosphere, oxidation by oxygen that diffuses into the agricultural products from the environment, mechanical damage to the surface, and/or light-induced degradation (i.e., photodegradation). Furthermore, biotic stressors, such as bacteria, fungi, viruses, and/or pests, can infest and decompose the agricultural products.

As a natural defense against spoilage, the aerial surfaces of all land plants are covered by a thin, highly cross-linked polyester known as cutin. Depositing an edible coating atop this cutin layer has been shown to reduce water loss and/or oxidation while helping resist surface abrasion. Edible coatings can be deposited on the product surfaces by first adding the constituents of the coating to a solvent to form a mixture (e.g., a solution, suspension, colloid or emulsion), then applying the mixture to the surface, and finally allowing the solvent to evaporate, thereby allowing the coating constituents to form the coating.

The mixture containing the coating constituents can be applied to the products being coated in a number of ways. For example, the products can be dipped in a bath of the mixture, after which they are removed and placed on drying racks. Alternatively, the products can be sprayed with the mixture, and can optionally be simultaneously rotated to ensure complete coverage. It is typically desirable that the deposition methods used to deposit the coatings result in complete (or near complete) coverage of the products while also being compatible with other processes and equipment used to clean, treat, and sort the products in commercial facilities.

### SUMMARY

Described herein are methods and devices for treating substrates (e.g., produce, perishable items, or other items) in order to protect them from degradation and decomposition (e.g., spoilage). The methods generally include forming a protective coating on the outer surface of the substrate from a mixture (e.g., a solution, a colloid, a suspension, or an emulsion) that includes a coating agent in a solvent. The mixture is applied to the surface by forming a fog, the fog being formed of droplets of the mixture that have an average diameter of about 100 microns or smaller, and allowing the fog to contact the surface of the substrate so that a portion of the mixture accumulates on at least a portion of the surface of the substrate. The solvent from the mixture is then at least partially removed from the surface (e.g., by evaporation or forced convection), and the coating agent that remains on the surface forms the protective coatings. The protective coatings can, for example, serve to preserve the substrates and to protect them from mechanical damage or from biotic or abiotic stressors such as mass or moisture loss, oxidation, mold, fungi, or infestation.

Accordingly, in a first aspect, a method of forming a protective coating on a surface of a substrate can include forming a fog comprising droplets of a mixture, the mixture comprising a coating agent in a solvent, and causing the fog to contact at least a portion of the surface of the substrate so that a portion of the mixture accumulates on at least a portion of the surface of the substrate. The method can further include at least partially removing the solvent from the mixture on the surface of the substrate, thereby forming a protective coating from the coating agent on at least a portion of the surface of the substrate.

In a second aspect, a method of forming a protective coating on a surface of a substrate can include forming a first fog comprising droplets of a first mixture, the first mixture comprising a first coating agent in a first solvent, and causing the first fog to contact the surface of the substrate so that a portion of the first mixture accumulates on at least a portion of the surface of the substrate. The method can further include at least partially removing the first solvent from the mixture on the surface of the substrate, thereby forming a first protective coating from the first coating agent on at least part of the surface of the substrate. The method can further include forming a second fog comprising droplets of a second mixture, the second mixture comprising a second coating agent in a second solvent, and causing the second fog to contact one or both of the first protective coating on the surface of the substrate or the surface of the substrate that was incompletely coated with the first protective coating so that the second mixture accumulates on one or both of a portion of the first protective coating on the surface of the substrate or at least a portion of the surface of the substrate that was incompletely coated with the first protective coating. The method can further include at least partially removing the second solvent from the second mixture on the surface of the substrate, thereby forming a second protective coating from the second coating agent on at least a portion of one or both of the surface of the substrate that was incompletely coated with the first protective coating or the first protective coating on the surface of the substrate. The first mixture can be the same as or different from the second mixture. The first fog can be applied to the substrate for about the same amount of time as the second fog or for a different amount of time than the second fog.

In a third aspect, a method of forming a protective coating on the surface of a plurality of items in a container can include causing a fog comprising droplets of a mixture to enter the container through one or more openings in the container, the mixture comprising a coating agent in a solvent. The fog can then disperse through the interior of the container to contact the plurality of items, thereby causing a protective coating to be formed from the coating agent on at least a part of the plurality of items.

In a fourth aspect, a method of forming a protective coating on the surface of a plurality of items can include forming a fog in an enclosure, the fog including droplets of a mixture, wherein the mixture includes a coating agent in a solvent. The method can further include after at least partially forming the fog, moving the plurality of items into the enclosure, thereby causing the fog to contact the plurality items so that a portion of the mixture accumulates on the surfaces of the plurality of items. The method can also include causing the solvent to be at least partially removed from the mixture on the surface of the items, thereby forming the protective coating from the coating agent on at least a part of the surface of the plurality of items.

In a fifth aspect, a method of forming a protective coating on the surface of pre-harvested produce can include forming a fog comprising droplets of a mixture, the mixture comprising a coating agent in a solvent. The method can further include causing the fog to contact the outer surfaces of the pre-harvested produce so that a portion of the mixture accumulates on the surface of the pre-harvested produce, thereby causing a protective coating to be formed from the coating agent on at least a part of the surface of the pre-harvested produce. Furthermore, the fog disperses through openings around the pre-harvested produce to improve coverage of the protective coating on the outer surfaces of the pre-harvested produce.

In a sixth aspect, a method of forming a protective coating on a surface of a substrate can include heating a mixture to form a vapor, wherein the mixture comprises a coating agent in a solvent, and cooling the vapor to form a fog. The method can further include causing the fog to contact the surface of the substrate so that a portion of the mixture accumulates on the surface of the substrate, thereby causing a protective coating to be formed from the coating agent on at least part of the surface of the substrate.

In a seventh aspect, an assembly for applying a protective coating to a substrate can include a reservoir having a mixture therein, the mixture comprising a coating agent in a solvent. The assembly can further include a heat exchanger and a pump configured to force the mixture through the heat exchanger. The heat exchanger can be capable of being heated to a sufficiently high temperature to cause the mixture to become a vapor as it is forced through the heat exchanger.

Any of the methods or assemblies described herein can include one or more of the following steps or features, either alone or in combination with one another. The substrate or items can be perishable. The substrate or items can be a plant or can comprise produce, for example pre-harvested or post-harvested produce. The substrate or items can be maintained within the fog for less than 2 minutes so that a portion of the mixture accumulates on the surface of the substrate or items. Causing the protective coating to be formed from the coating agent on at least a portion of the surface of the substrate or items can include at least partially removing the solvent from the mixture on the surface of the substrate or items. At least 95% of the solvent can evaporate after 30 minutes or less. Causing the protective coating to be formed from the coating agent on the substrate or items can include cooling or drying the substrate or items via convection through at least one of the openings in a container. Forming the fog can include heating the mixture to form a vapor, and cooling the vapor to form the fog. The droplets of the fog can have an average diameter of about 100 microns or smaller. Heating the mixture can include passing the mixture through a heat exchanger that is held at a temperature of at least 150° C. The protective coating can be at least 0.1 microns thick. The protective coating can be edible. The solvent can include water and/or ethanol. The coating agent can include monomers, oligomers, fatty acids, esters, amides, amines, thiols, carboxylic acids, ethers, aliphatic waxes, alcohols, or salts. The coating agent can include a compound of Formula I, wherein Formula I is defined below. The assembly can further include a nozzle, and optionally the assembly can be configured such that the vapor becomes a fog as it exits the nozzle, and droplets of the fog can comprise the coating agent and the solvent.

As used herein, a “substrate” refers to any object or material over whose surface a protective coating is formed. Although in many applications the coating is formed on the entire outer surface of the substrate, in some applications the coating may not cover the entire outer surface or may include apertures or porous regions which expose a portion of the outer surface of the substrate.

As used herein, a “cationic moiety” is any organic or inorganic positively charged ion.

The following abbreviations are used throughout. Hexadecanoic acid (i.e., palmitic acid) is abbreviated to “PA”. Octadecanoic acid (i.e., stearic acid) is abbreviated to “SA”. Tetradecanoic acid (i.e., myristic acid) is abbreviated to “MA”. (9Z)-Octadecenoic acid (i.e., oleic acid) is abbreviated to “OA”. Dodecanoic acid (e.g., 1 auric acid) is abbreviated to “LA”. Undecanoic acid (e.g., undecylic acid) is abbreviated to “UA”. Decanoic acid (e.g., capric acid) is abbreviated to “CA”. 1,3-dihydroxypropan-2-yl palmitate (i.e., 2-glycero palmitate) is abbreviated to “PA-2G”. 1,3-dihydroxypropan-2-yl octadecanoate (i.e., 2-glycero stearate) is abbreviated to “SA-2G”. 1,3-dihydroxypropan-2-yl tetradecanoic acid (i.e., 2-glycero myristate) is abbreviated to “MA-2G”. 1,3-dihydroxypropan-2-yl (9Z)-Octadecenoate (i.e., 2-glycero oleate) is abbreviated to “OA-2G”. 2,3-dihydroxypropan-1-yl palmitate (i.e., 1-glycero palmitate) is abbreviated to “PA-1G”. 2,3-dihydroxypropan-1-yl octadecanoate (i.e., 1-glycero stearate) is abbreviated to “SA-1G”. 2,3-dihydroxypropan-1-yl tetradecanoate (i.e., 1-glycero myristate) is abbreviated to “MA-1G”. 2,3-dihydroxypropan-1-yl (9Z)-Octadecenoate (i.e., 1-glycero oleate) is abbreviated to “OA-1G”. 2,3-dihydroxypropan-1-yl dodecanoate (i.e., 1-glycero laurate) is abbreviated to “LA-1G”. 2,3-dihydroxypropan-1-yl undecanoate (i.e., 1-glycero undecanoate) is abbreviated to “UA-1G”. 2,3-dihydroxypropan-1-yl decanoate (i.e., 1-glycero caprate) is abbreviated to “CA-1G”. Sodium salt of stearic acid is abbreviated to “SA-Na”. Sodium salt of myristic acid is abbreviated to “MA-Na”. Sodium salt of palmitic acid is abbreviated to “PA-Na”. Potassium salt of stearic acid is abbreviated to “SA-K”. Potassium salt of myristic acid is abbreviated to “MA-K”. Potassium salt of palmitic acid is abbreviated to “PA-K”. Calcium salt of stearic acid is abbreviated to “SA-Ca”. Calcium salt of myristic acid is abbreviated to “MA-Ca”. Calcium salt of palmitic acid is abbreviated to “PA-Ca”. Magnesium salt of stearic acid is abbreviated to “SA-Mg”. Magnesium salt of myristic acid is abbreviated to “MA-Mg”. Magnesium salt of palmitic acid is abbreviated to “PA-Mg”.

### BRIEF DESCRIPTION OF THE DRAWINGS

FIG. 1 is a schematic diagram of a fogger producing a fog and the fog being applied to a substrate.

FIG. 2 illustrates a method of forming a protective coating over a surface of a substrate.

FIG. 3 illustrates a method for forming a protective coating on the surfaces of a plurality of items in a container.

FIG. 4 illustrates another method for forming a protective coating on the surfaces of a plurality of items.

FIG. 5 illustrates a method of forming a protective coating on the surface of pre-harvested produce.

FIG. 6 is a photograph of a fogger configured to apply a fog to avocados inside a container.

FIG. 7 is a photograph of chamber that can be filled with produce or other substrates to be coated via fogging as described herein.

FIG. 8 is a plot of mass loss rates of strawberries coated by fogging as described herein and then stored in ambient conditions.

FIG. 9 is a plot of mass loss rates of strawberries coated by fogging as described herein and then stored in cold storage conditions.

Like numerals in the figures represent like elements.

### DETAILED DESCRIPTION

Protective coatings can be used in a variety of applications to protect items from mechanical damage, degradation, decomposition, spoilage, and as a barrier to water and gas transfer into or out of the items. In the case of perishable items such as harvested produce, edible coatings have been used to increase the shelf life by reducing both the rate of water loss from the items and the rate of oxygen diffusion into the items. The coatings can be deposited on the surfaces of the items by first adding the constituents of the coating (herein a “coating agent”) to a solvent to form a mixture (e.g., a solution, a suspension, a colloid or an emulsion), then applying the mixture to the surfaces of the items, and finally removing the solvent (e.g., by evaporation or forced convection), thereby allowing a coating to form from the coating agent on the surfaces of the items.

Described herein are processes for depositing protective coatings that allow for increased coverage of the coated substrates, avoid damage that can be caused by overexposure to solvent, and are compatible with a number of configurations that items such as produce are packaged into for distribution. In each of the processes, a fog is formed from a mixture which includes a coating agent in a solvent, and the droplets of the fog are applied to the surface of one or more substrates. As used herein, a “fog” refers to a collection of droplets that have an average diameter of less than about 150 microns. In particular, droplets of a fog may be sufficiently small that they are effectively suspended in the atmosphere and take some time to settle towards the ground under the influence of gravity. This allows droplets of a fog to diffuse through small or narrow openings before gravity pulls the droplets towards the earth, and can thereby result in improved surface coverage as compared to conventional spray coating methods. For example, a fog that is applied into a container containing a plurality of substrates can diffuse through openings between the substrates and eventually settle on substrate surfaces that would typically not be accessible via a conventional spray.

Any of the fogs described herein can be formed as either a wet fog or a dry fog. A wet fog is formed of larger droplets than a dry fog. For example, a wet fog may typically contain droplets having an average diameter between about 25 and 100 microns (and in some embodiments about 30 microns), whereas a dry fog may typically contain droplets having an average diameter between about 5 and 20 microns (and in some embodiments, about 10 microns). In some cases, it may be preferable that the fog be a dry fog or be formed of droplets having an average diameter of at least 5 microns, at least 10 microns, at least 15 microns, or at least 20 microns. When a dry fog is used and/or when the droplets are too small, in some cases the time required to achieve sufficient coverage of the substrate surface can be long. When droplets of the fog are sufficiently large and/or the fog is sufficiently dense, sufficient coverage of the substrate can be achieved if the substrate is maintained within the fog for less than 3 minutes, less than 2 minutes, less than 90 seconds, less than 75 seconds, less than 1 minute, less than 50 seconds, less than 40 seconds, or less than 30 seconds.

Any of the fogs (wet and dry fogs) formed from mixtures described herein (e.g., a solution, suspension, colloid, or emulsion including a coating agent in a solvent) can be formed by the following thermal fogging method. The mixture contained within a fluid tank is forced through a high temperature heat exchanger by a pump, for example, a high-pressure pump, causing the mixture to vaporize. The heat exchanger can be held at a temperature of at least 150° C., at least 200° C., at least 250° C., or at least 300° C. This vapor is then emitted into the atmosphere. When the vapor comes into contact with the relatively cooler atmosphere and begins to expand, it condenses into the small droplets that make up the fog. Other thermal and non-thermal methods recognizable to those skilled in the art can also be used to form the fog, including, but not limited to ultrasonic fogging, or the use of a rotating atomizer, or pulse jet thermal fogger.

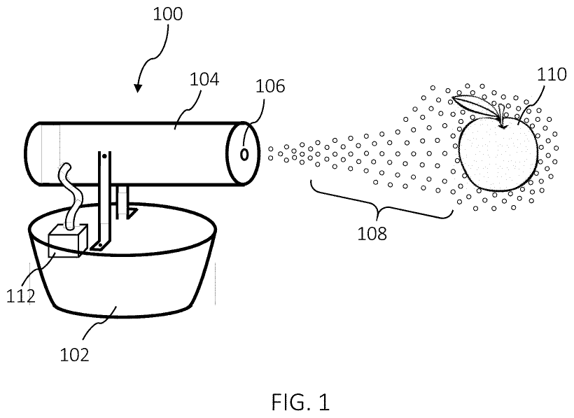

FIG. 1 shows a schematic diagram of a fogger 100 producing any of the fogs herein, and the fog then being applied to a substrate 110 to form a protective coating on the surface of the substrate. The fogger 100 includes a reservoir 102 which contains the fluid (e.g., the coating agent and solvent mixture) from which the fog is formed. A pump 112 forces the fluid through a heat exchanger 104, where the fluid is heated to a sufficiently high temperature to cause it to vaporize. The vapor is then emitted through a nozzle 106 into the atmosphere, where it condenses and becomes a fog 108. The fog 108 is then directed towards the surface of the substrate 110 (e.g., by directly fogging the substrate 110 or by first forming the fog 108 and then placing the substrate 110 in the fog 108), where it diffuses around and eventually settles (e.g., accumulates) on the surface of the substrate 110. In some implementations, a temperature difference between the substrate 110 and the fog 108 causes the droplets of the fog to accumulate on and/or adhere to the surface of the substrate 110. Once sufficient coverage of the surface of the substrate 110 is achieved (a feature readily determined by the skilled worker), the substrate is removed from the fog and the solvent from the mixture that is on the surface of the substrate 110 is at least partially removed, for example by evaporation and/or forced convection. The coating agent remains on the surface of the substrate 110 and forms a protective coating.

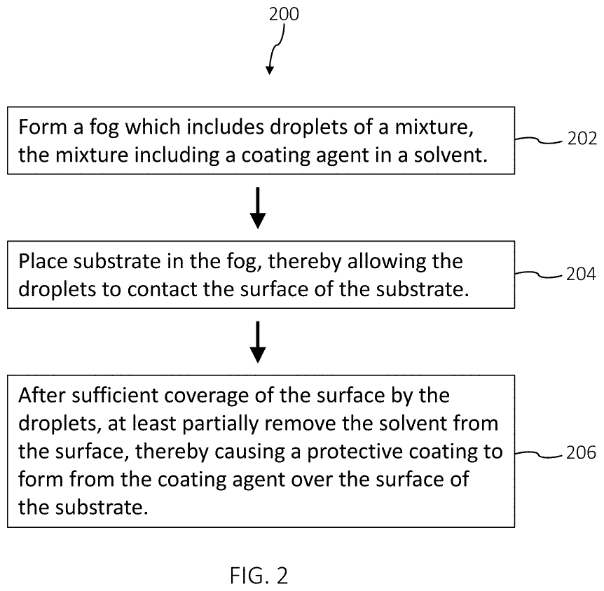

FIG. 2 illustrates a method 200 of forming a protective coating on a surface of a substrate. First, a fog is formed from a mixture (e.g., a solution, suspension, emulsion, or colloid) that includes a coating agent in a solvent (step 202). The fog can, for example, be formed by any of the fogging methods described herein. Next, a substrate is placed in the fog, and the fog is allowed to contact the surface of the substrate (step 204) so that a portion of the mixture accumulates on the surface of the substrate. In some cases, placing the substrate in the fog includes keeping the substrate in place and causing the fog to contact the substrate. In other cases, placing the substrate in the fog includes forming a fog and then moving the substrate into the fog. Finally, after sufficient coverage of the surface of the substrate by the mixture is achieved, the solvent is at least partially removed from mixture on the surface of the substrate, thereby causing a protective coating to be formed from the coating agent on at least a majority of the surface (step 206). The removal (or partial removal) of the solvent can, for example, be achieved by allowing the solvent to evaporate (and optionally simultaneously heating the substrate to expedite evaporation), via forced convection (e.g., by blowing air or nitrogen or another gas onto the substrate), or a combination thereof.

The method 200 of FIG. 2 can provide one or more of the following advantages over other techniques used to apply mixtures to the surfaces of substrates to form protective coatings, (i) The substrates (or containers holding the substrates) do not need to be manually handled during the application of the mixtures (as typically required for dip coating), (ii) Reduced exposure of the substrate to the solvents can result in reduced damage or degradation that may be caused to the substrate by the solvent, (iii) Improved and/or more complete coverage of the surface by the droplets can in some cases be achieved as compared to conventional spray coating, in particular for substrates with irregular shaped surfaces, (iv) In some cases, the entire surface of the substrates can be treated without needing to turn or otherwise move the substrates during application, as may be required in the case of conventional spray coating, (v) In many cases, the substrates can be dried (and the solvent at least partially removed) substantially faster when the mixture is applied via fogging as compared to other application techniques. For example, at least 90% (e.g., at least 95%) of the solvent can be removed from the surface in 30 minutes or less, 25 minutes or less, 20 minutes or less, 15 minutes or less, 10 minutes or less, 5 minutes or less, 3 minutes or less, or 1 minute or less.

The fogging methods described herein for forming protective coatings over items and substrates can be useful and advantageous for applying coatings to a plurality of substrates in a container (e.g., produce in a reefer or other shipping container, produce contained in a modified atmospheric package, or produce packaged in a box or other container for shipping). For example, rather than removing the items from the container in order to apply the coating mixture to the items, a fog including droplets of the mixture can be directed into the container, e.g., through an opening in the container. The fog then diffuses through openings between adjacent substrates to contact a majority of the exposed surfaces of substrates within the container.

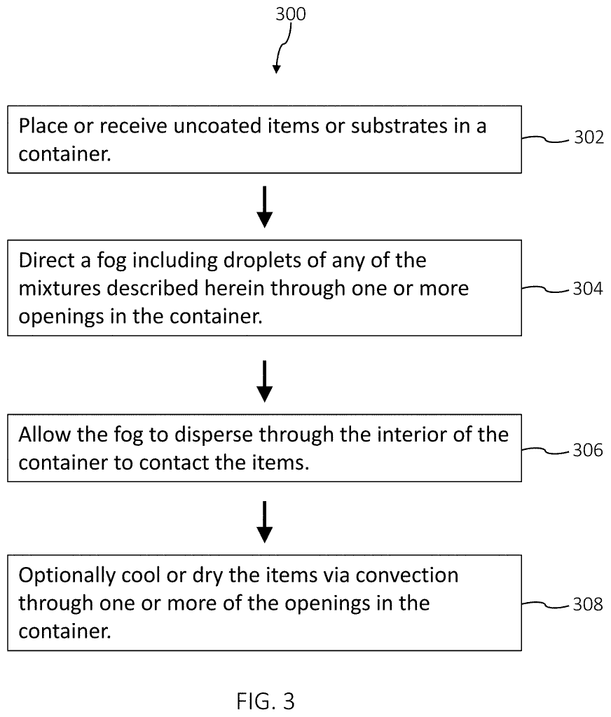

In view of the above, a method 300 for forming a protective coating over a plurality of items in a container is illustrated in FIG. 3. First, uncoated items are placed or received in a container (step 302). Next, a fog including droplets of any of the mixtures described herein is directed through one or more openings in the container (step 304). The fog is then allowed to disperse through the interior of the container to contact the items in the container (step 306) so that a portion of the mixture accumulates on the surface of the items. As with other methods of this disclosure, the solvent can then be removed at least partially from the mixture on the surfaces of the items and coatings can be formed from the coating agent in the mixture on the surface of at least a majority of the items. Optionally, the items can be cooled or dried via convection through one or more of the openings in the container (e.g., by blowing air, nitrogen, or another gas through one or more of the openings).

In some implementations, one or more of the fogs described herein is formed in an enclosure, and one or more items to be coated is then passed through the enclosure, thereby allowing droplets of the fog to at least partially cover the surface of the items as they pass through the enclosure. For example, items on a conveyor system (or in crates being moved via a conveyor system) can pass through an enclosed area in which the fog is formed, such that droplets of the fog are applied to the surfaces of the items.

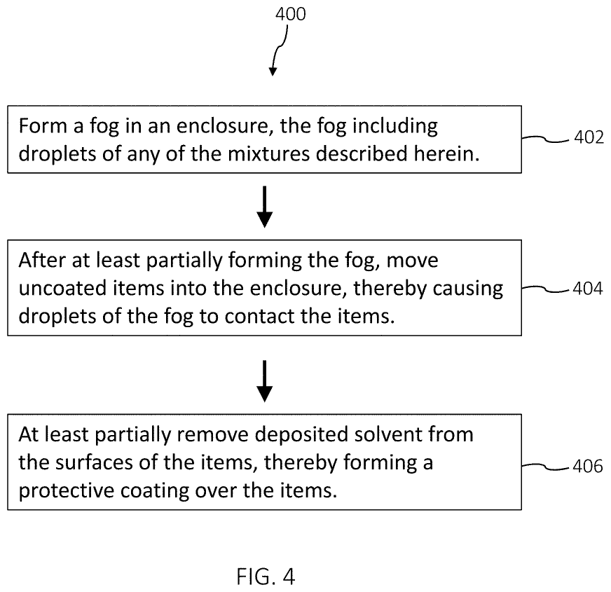

In view of the above, another method 400 for forming a protective coating over a plurality of items is illustrated in FIG. 4. First, a fog is formed in an enclosure, the fog being formed from a mixture including a coating agent in a solvent (step 402). After at least partially forming the fog, uncoated items are moved into the enclosure, allowing the fog to contact the items so that a portion of the mixture accumulates on the surface of the items until sufficient surface coverage of the items is achieved (step 404). The solvent from the mixture is then at least partially removed from the surfaces of the items, thereby forming a protective coating on the surface of the items (step 406).

In some embodiments at least 10% by mass of the solvent is removed from the surface of the items and/or substrate, such as, 15%, 20%, 25%, 30%, 35%, 40%, 45%, 50%, 55%, 60%, 65%, 70%, 75%, 80%, 85%, 90%, 95%, 96%, 97%, 98%, 99% or 100% by mass. The percent by mass of the solvent that has been removed can readily be determined using methods known to those skilled in the art. For example, the percent by mass of solvent removed can be determined according to the equation

$${\%}_{removed solvent} = ( 1 - \frac{( {M}_{x - {M}_{u}} )}{( {M}_{c - {M}_{u}} )} ) * 100 ,$$

wherein Mₓ is the mass of the substrate at time x, Mᵤ is the mass of the uncoated substrate, and M_{c} is the mass of the coated substrate immediately after it has been coated. Additionally, the percent of the solvent that has been removed from the surface of the substrate can alternatively be monitored using visual techniques, such as, for example, infrared spectroscopy, wherein the peaks in the spectrum attributable to the solvent, e.g., OH stretching peaks characteristic of water or an alcohol, are monitored over time.

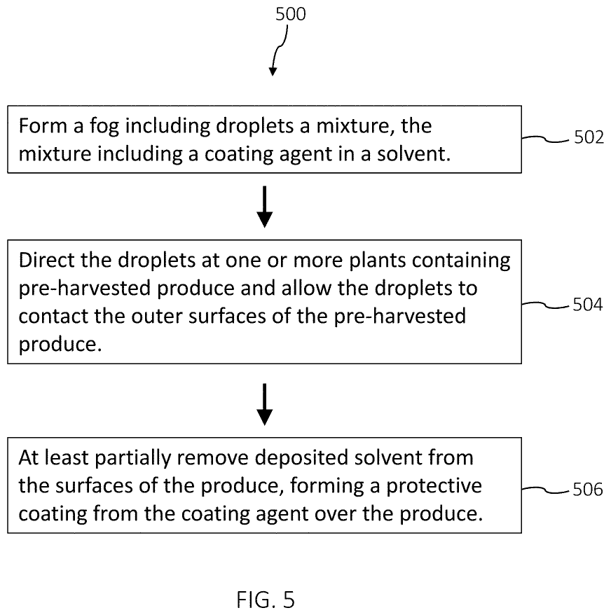

The fogging methods described herein can also be advantageous for forming protective coatings on the surfaces of pre-harvested produce, because the fog can disperse through openings around the pre-harvested produce to improve coverage of the protective coating on the outer surfaces of the pre-harvested produce. A method of forming a protective coating over pre-harvested produce is illustrated in FIG. 5. First, a fog including droplets of a mixture is formed, the mixture including a coating agent in a solvent (step 502). The fog is then directed at one or more plants containing the pre-harvested produce so that the droplets of the mixture in the fog contact the outer surfaces of the pre-harvested produce (step 504) so that a portion of the mixture accumulates on the surface of the pre-harvested produce. The fog is able to disperse through openings around the produce, thereby improving coverage of the produce by the mixture in the droplets of the fog. Finally, solvent from the mixture is at least partially removed from the produce (e.g., by allowing the solvent to evaporate), so that a protective coating is formed from the coating agent on at least part of the surface of the pre-harvested produce (step 506).

The pre-harvest produce can subsequently be harvested after the protective coating has been applied using the fogging methods described herein. Once the produce is harvested, a second protective coating can, if desired, be applied to the surface of the produce using the fogging methods described herein, or by more traditional spraying, misting or brushing a mixture including a coating agent, or by dipping the substrate into a mixture comprising a coating agent as described herein. Subsequent removal of at least a portion of the solvent from the mixture results in a second protective coating formed from the coating agent on at least a portion of the surface of the harvested produce (or on the surface of its pre-harvest coating).

For any of the fogging methods described herein for forming coatings, including those shown in FIGS. 2-5 and described above, multiple fogging layers (i.e., multiple coating layers formed by successively fogging the items and allowing them to dry) can be applied to the items being coated. For example, a first fog comprising first droplets of a first mixture can be formed, where the first mixture includes a first coating agent in a first solvent, and the first droplets can be directed to the surface of the item. The first solvent can then be at least partially removed from the surface (e.g., by evaporation), causing a first layer of the coating to be formed from the first coating agent on the surface of the item. The substrate can then be fogged a second time and subsequently dried to form a second layer of the protective coating on the surface of the substrate (or on its first coating). The mixture used to form the second layer of the coating can be the same as or different than the first mixture used to form the first layer. The residence time of the item in the first fog can be the same as or different than the residence time of the item in the second fog. The process can be further repeated to for additional layers, e.g., a third layer, a fourth layer, etc.

The fogging methods described herein can also be combined with other methods to form coatings on the surface of a substrate. For example, a base layer of the protective coatings according to this disclosure can be applied using the fogging methods described herein. Additional layers of the protective coating can then be applied to the surface of the substrate using the fogging methods described herein, or by more traditional methods, including, but not limited to, spraying, misting or brushing a mixture comprising a coating agent as described herein on the surface of the substrate, or dipping the substrate in a mixture comprising a coating agent. Alternatively, the fogging methods described herein may be used to reinforce a protective coating, preferably applied by a fogging method of this disclosure, that is already present on the surface of the substrate. For example, a substrate having a protective coating as described herein can undergo a second or subsequent treatment with a coating mixture as described herein using the fogging methods of this disclosure. For example, the fogging method described herein can serve to reinforce coatings that were applied to a substrate previously but have begun to experience wear and tear over time, thereby extending the beneficial effects of the protective coatings.

The droplets of any of the fogs described herein can, for example, have an average diameter of less than 100 microns, less than 95 microns, less than 90 microns, less than 85 microns, less than 80 microns, less than 75 microns, less than 70 microns, less than 65 microns, less than 60 microns, less than 55 microns, less than 50 microns, less than 45 microns, less than 40 microns, less than 35 microns, less than 30 microns, less than 25 microns, less than 20 microns, less than 15 microns, less than 10 microns, less than 5 microns, between 1 and 100 microns, between 1 and 95 microns, between 1 and 90 microns, between 1 and 85 microns, between 1 and 80 microns, between 1 and 75 microns, between 1 and 70 microns, between 1 and 65 microns, between 1 and 60 microns, between 1 and 55 microns, between 1 and 50 microns, between 1 and 45 microns, between 1 and 40 microns, between 1 and 35 microns, between 1 and 30 microns, between 1 and 25 microns, between 1 and 20 microns, between 1 and 15 microns, between 1 and 10 microns, between 1 and 5 microns, between 5 and 100 microns, between 5 and 95 microns, between 5 and 90 microns, between 5 and 85 microns, between 5 and 80 microns, between 5 and 75 microns, between 5 and 70 microns, between 5 and 65 microns, between 5 and 60 microns, between 5 and 55 microns, between 5 and 50 microns, between 5 and 45 microns, between 5 and 40 microns, between 5 and 35 microns, between 5 and 30 microns, between 5 and 25 microns, between 5 and 20 microns, between 5 and 15 microns, between 5 and 10 microns, between 25 and 100 microns, between 25 and 95 microns, between 25 and 90 microns, between 25 and 85 microns, between 25 and 80 microns, between 25 and 75 microns, between 25 and 70 microns, between 25 and 65 microns, between 25 and 60 microns, between 25 and 55 microns, between 25 and 50 microns, between 25 and 45 microns, or between 25 and 40 microns.

In some embodiments, contacting the surface of one or more substrates with a fog according to this disclosure using the methods described herein results in a protective coating that covers 50 to 100% of the surface of the one or more substrates. For example, in some embodiments the protective coating described herein covers 50%, 55%, 60%, 65%, 70%, 75%, 80%, 85%, 90%, 95%, 96%, 97%, 98%, 99% or 100% of the surface of the substrate.

The coating agent can be any compound or combination of compounds that can form a protective coating on at least part of the surface of the substrate via the methods described above. The coating agent can be formulated such that the resulting coating protects at least to some extent the substrate from biotic and/or abiotic stressors. For example, the coating can prevent or suppress the transfer of oxygen and/or water, thereby preventing at least to some extent the substrate from oxidizing and/or from losing water via transpiration/osmosis/evaporation. The coating agent can additionally or alternatively be formulated such that the resulting coating provides, at least to some extent, a barrier to CO₂, ethylene and/or other gas transfer. In cases where the substrate is perishable and/or edible, for example when the substrate is a plant, an agricultural product, or a piece of produce, the coating agent is preferably composed of non-toxic compounds that are safe for consumption and have no taste. For example, the coating agent can be formed from or include fatty acids and/or salts or esters thereof. The fatty acid esters can, for example, be ethyl esters, methyl esters, or glyceryl esters (e.g., 1-glyceryl or 2-glyceryl esters).

The coating agent in any of the mixtures described herein can, for example, include fatty acids and/or salts or esters thereof. In some implementations, the coating agent includes monoacylglycerides (e.g., 1-monoacylglycerides or 2-monoacylglycerides). In some embodiments, the coating agent includes at least one of monomers, oligomers, fatty acids, esters, amides, amines, thiols, carboxylic acids, ethers, aliphatic waxes, alcohols, or salts (organic or inorganic salts). The monomers, oligomers, fatty acids, esters, amides, amines, thiols, carboxylic acids, ethers, aliphatic waxes, alcohols, salts, or combinations thereof can, for example, be derived from plant matter such as cutin.

Coating agents including fatty acids (e.g., palmitic acid, stearic acid, myristic acid, and/or other fatty acids) and/or esters or salts thereof can both be safe for human consumption and can be used as coating agents to form coatings that are effective at reducing mass loss and oxidation in a variety of produce. For example, coatings formed from coating agents that include various combinations of palmitic acid, myristic acid, stearic acid, 1-glyceryl esters of palmitic acid (i.e., 2,3-dihydroxypropan-1-yl palmitate, herein “PA-1G”), 2-glyceryl esters of palmitic acid (i.e., 1,3-dihydroxypropan-2-yl palmitate, herein “PA-2G”), 1-glyceryl esters of myristic acid (i.e., 2,3-dihydroxypropan-1-yl tetradecanoate, herein “MA-1G”), 1-glyceryl esters of stearic acid (i.e., 2,3-dihydroxypropan-1-yl octadecenoate, herein “SA-1G”), and/or other fatty acids or salts or esters thereof have been shown to be effective at reducing mass loss rates in many types of produce, for example finger limes, avocados, blueberries, and lemons. Any of the coating agents herein can include any of the compounds listed above.

In some implementations, the coating agent includes one or more compounds of Formula I, wherein Formula I is:

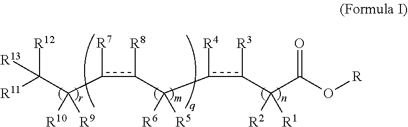

wherein:

R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

In some embodiments, R is selected from —H, —CH₃, or —CH₂CH₃. In some embodiments, R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more C₁-C₆ alkyl or hydroxyl. In some embodiments, R is a cationic moiety. The compounds of Formula I can include salts (e.g., when R is a cationic moiety), for example sodium salts such as SA-Na, PA-Na, or MA-Na, potassium salts such as SA-K, PA-K, or MA-K, calcium salts such as SA-Ca, PA-Ca, or MA-Ca, or magnesium salts such as SA-Mg, PA-Mg, or MA-Mg.

In some embodiments, the coating agent comprises monoacylglycerides (e.g., 1-monoacylglycerides or 2-monoacylglycerides). The difference between a 1-monoacylglyceride and a 2-monoacylglyceride is the point of connection of the glyceryl ester. Accordingly, in some embodiments, the coating agent comprises compounds of the Formula I-A (e.g., 2-monoacylglycerides):

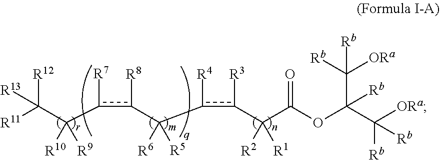

wherein:

each R^{a} is independently —H or —C₁-C₆ alkyl;

each R^{b} is independently selected from —H, —C₁-C₆ alkyl, or —OH;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

In some embodiments, the coating agent comprises compounds of the Formula I-B (e.g., 1-monoacylglycerides):

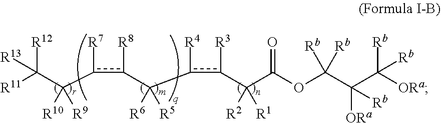

wherein:

each R^{a} is independently —H or —C₁-C₆ alkyl;

each R^{b} is independently selected from —H, —C₁-C₆ alkyl, or —OH;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

Any of the coating agents used in mixtures herein can include one or more of the following fatty acid compounds:

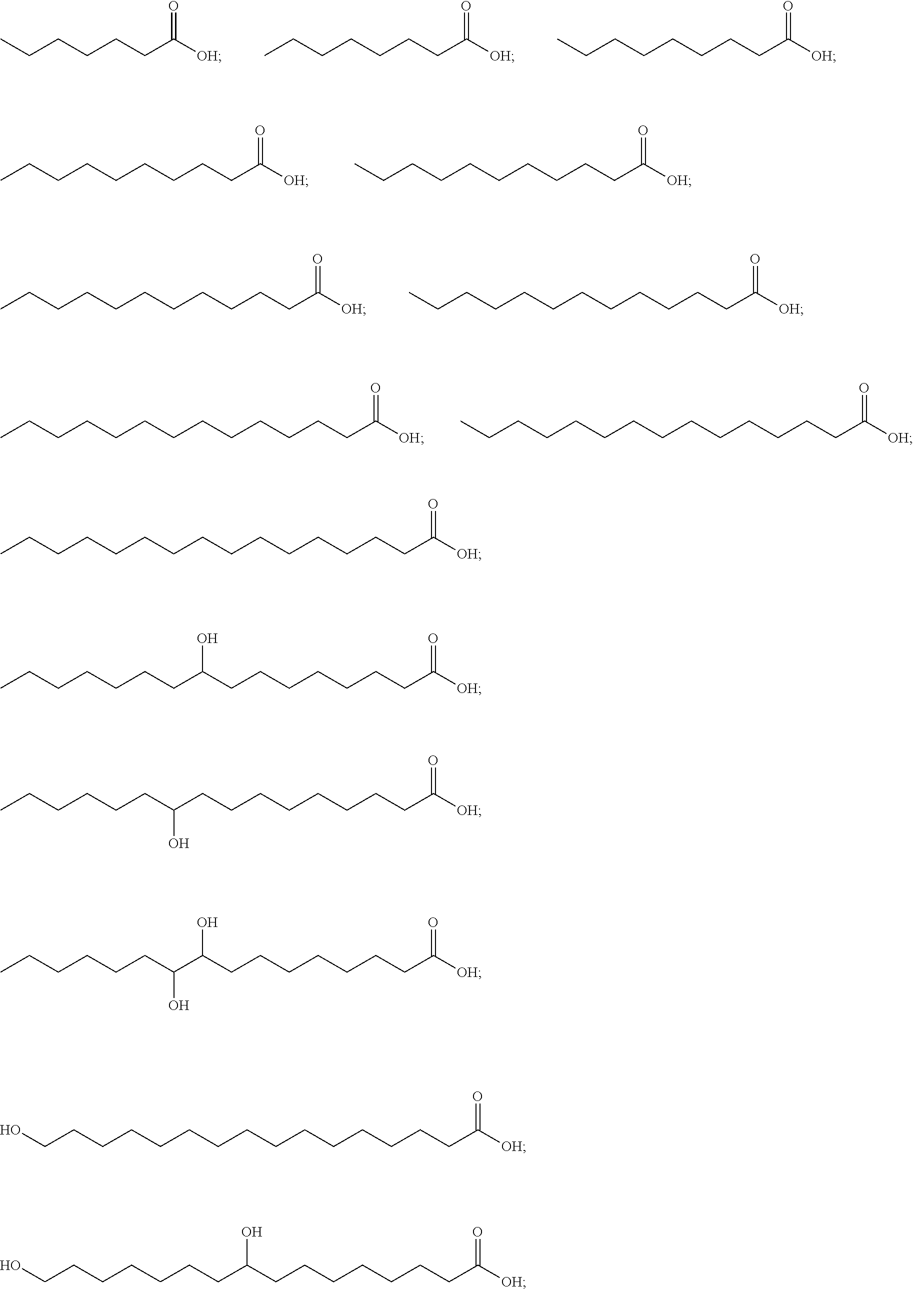

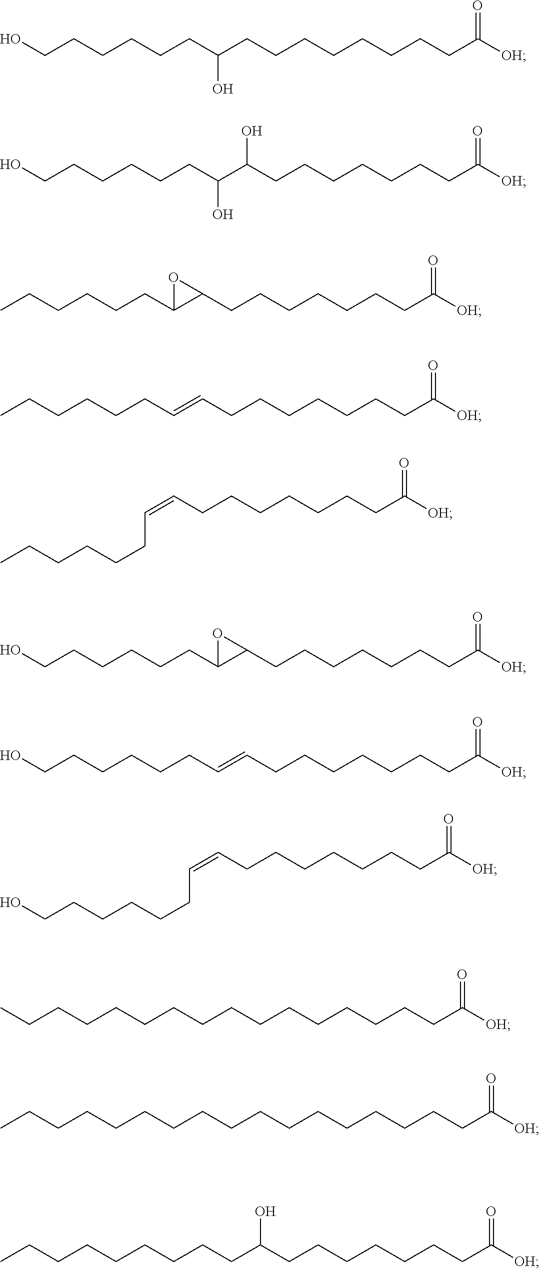

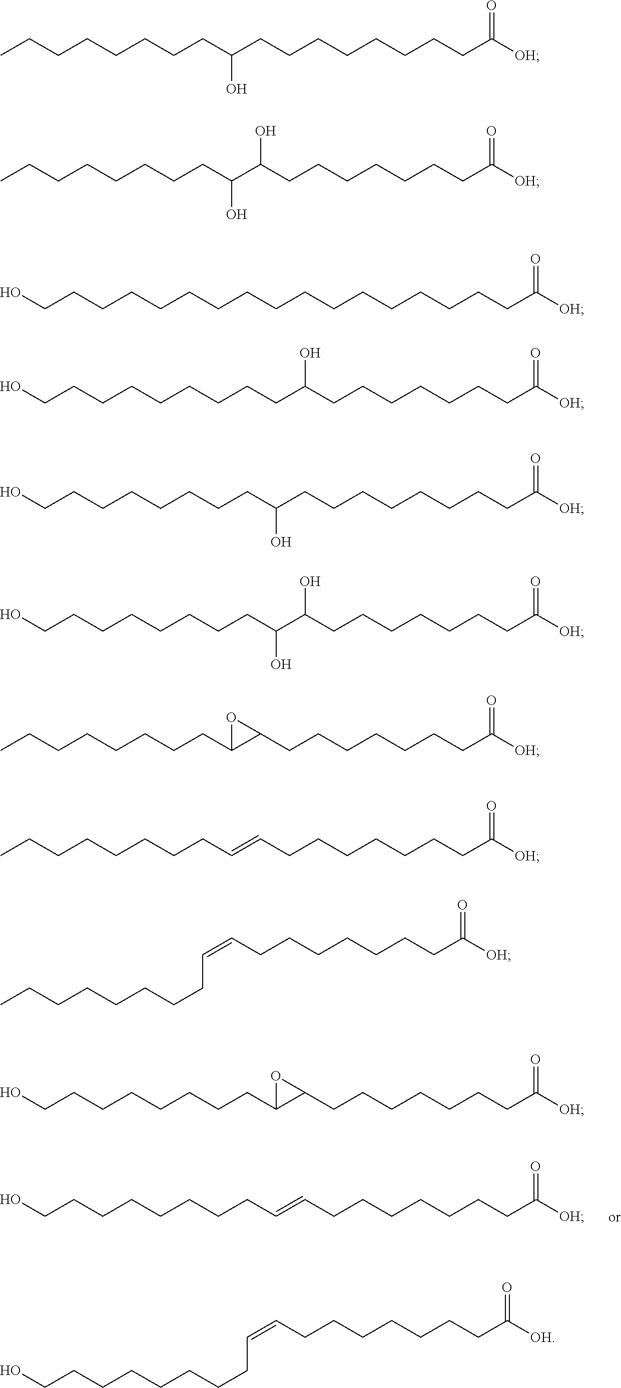

Any of the coating agents used in mixtures herein can include one or more of the following fatty acid methyl ester compounds:

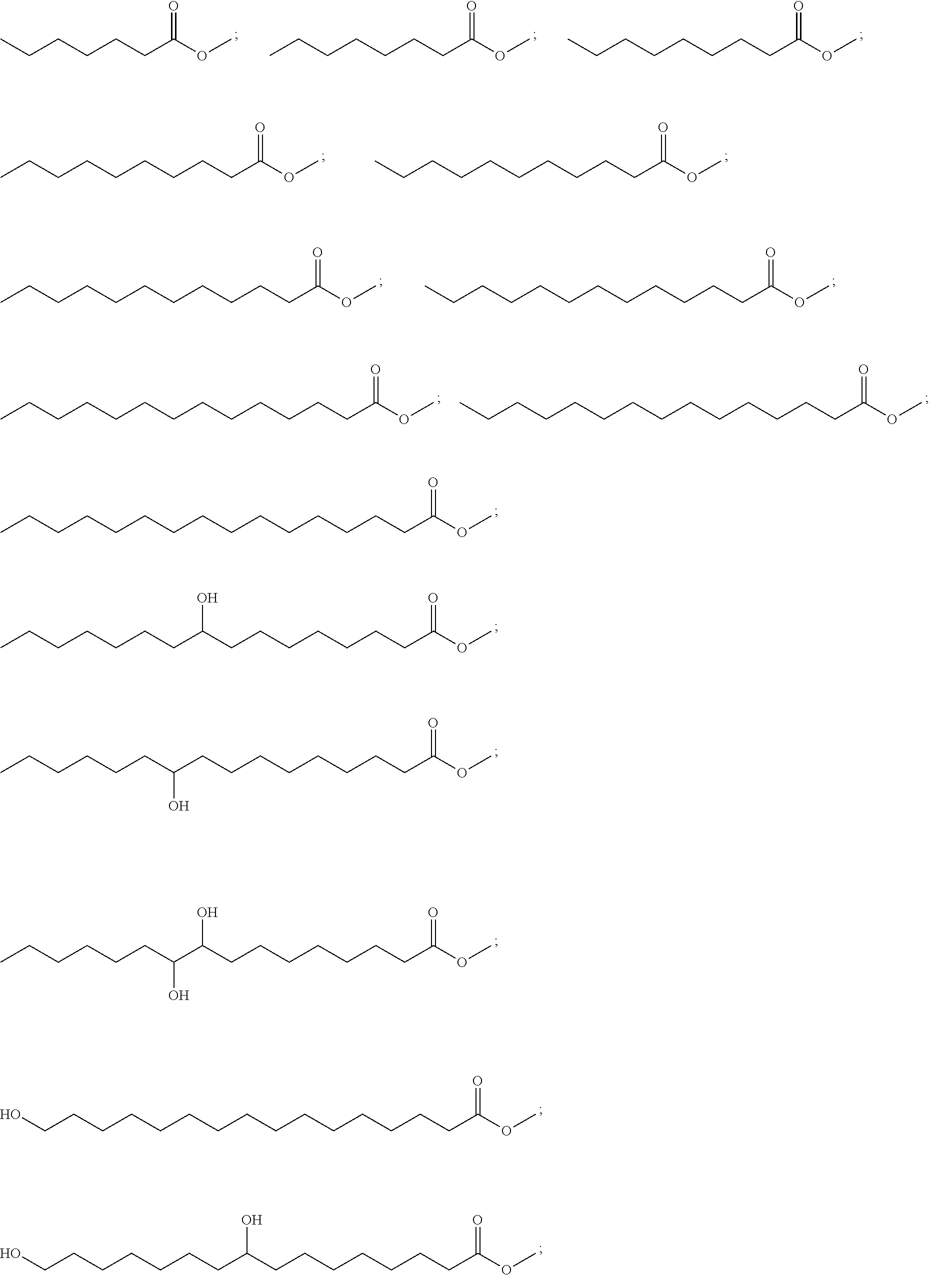

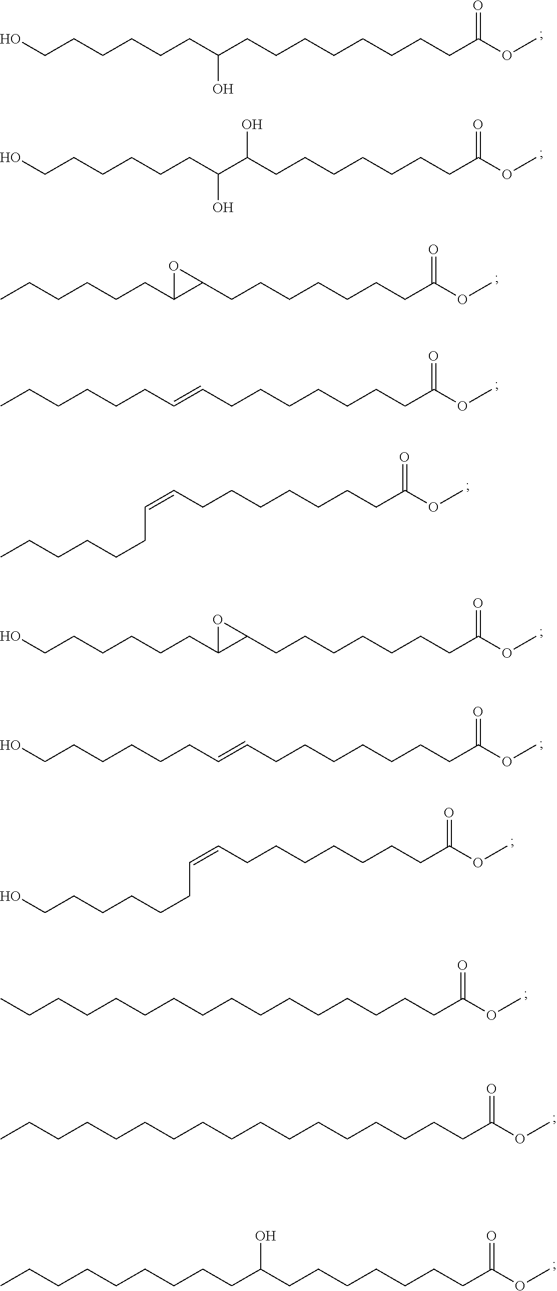

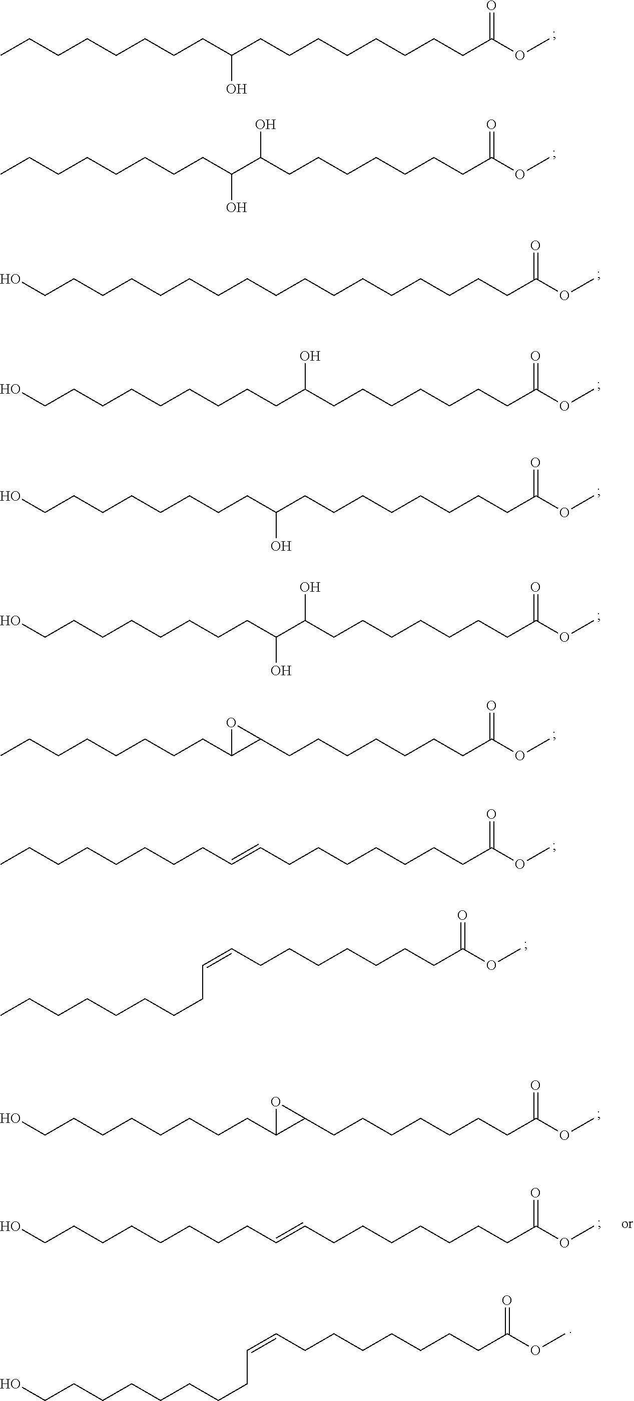

Any of the coating agents used in mixtures herein can include one or more of the following fatty acid ethyl ester compounds:

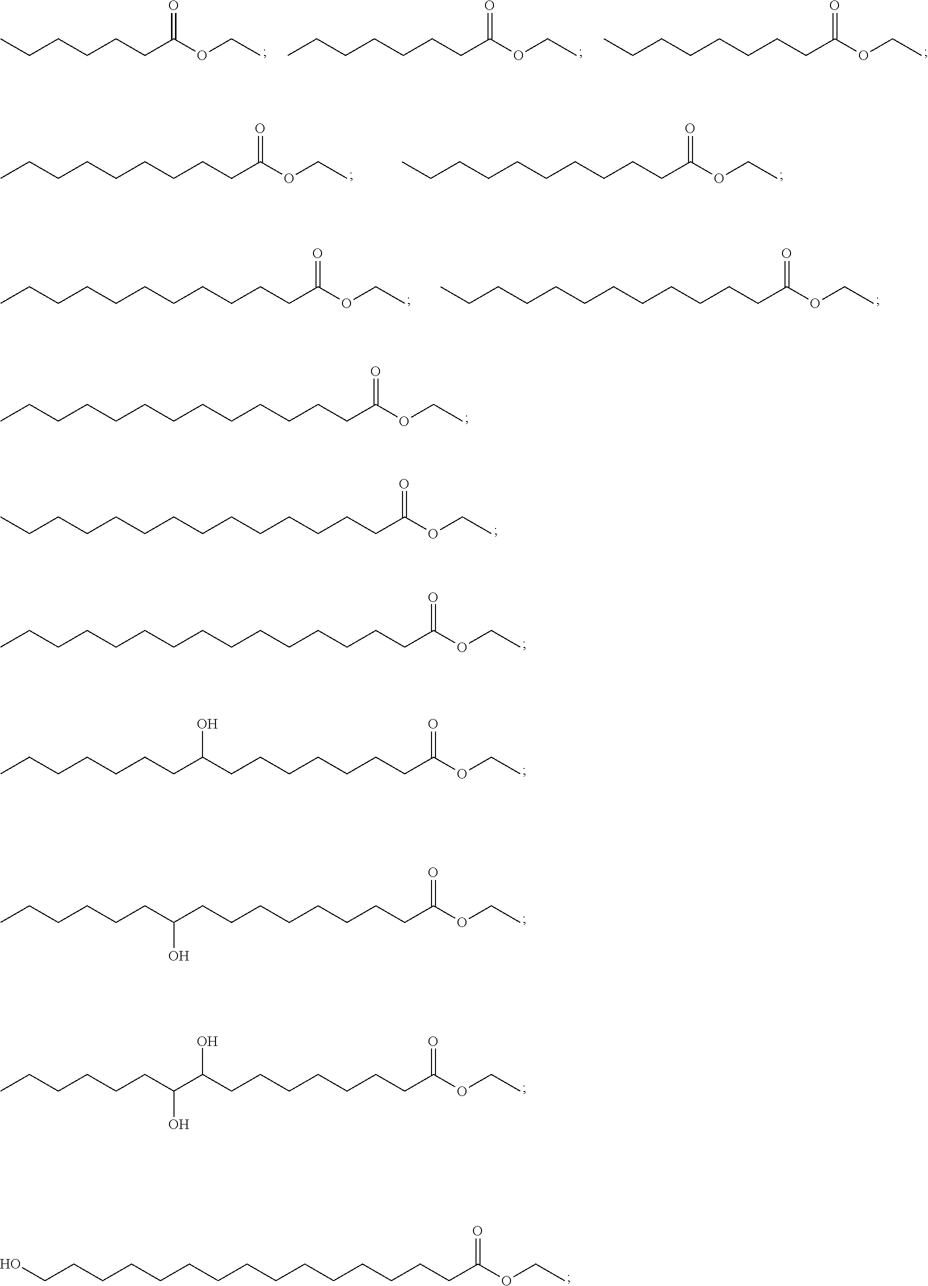

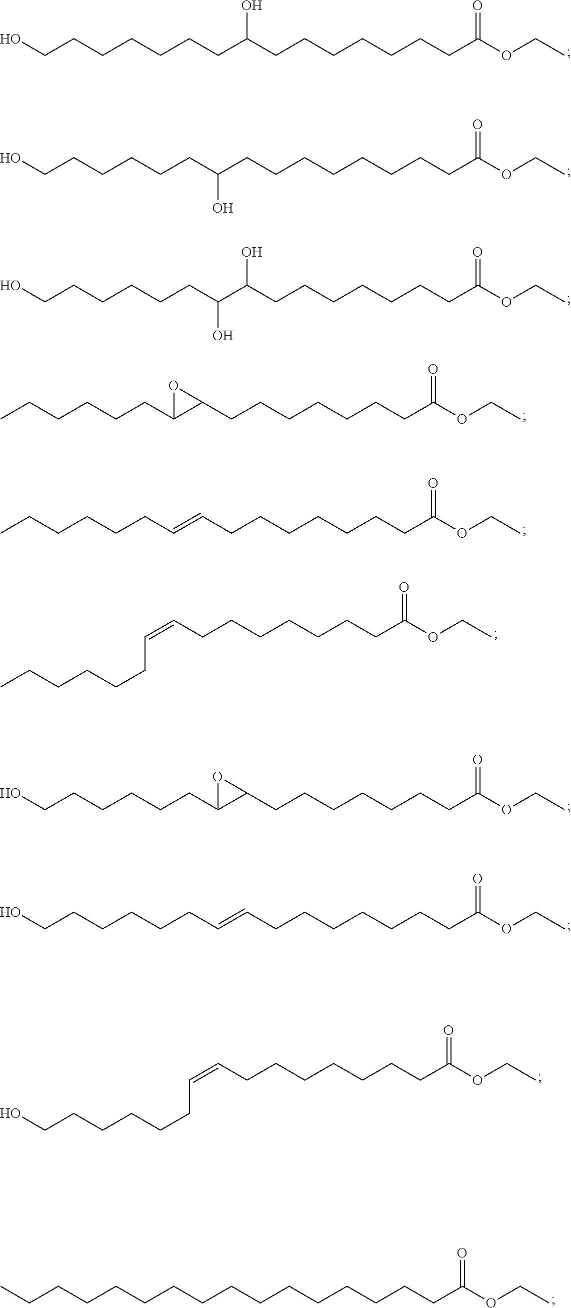

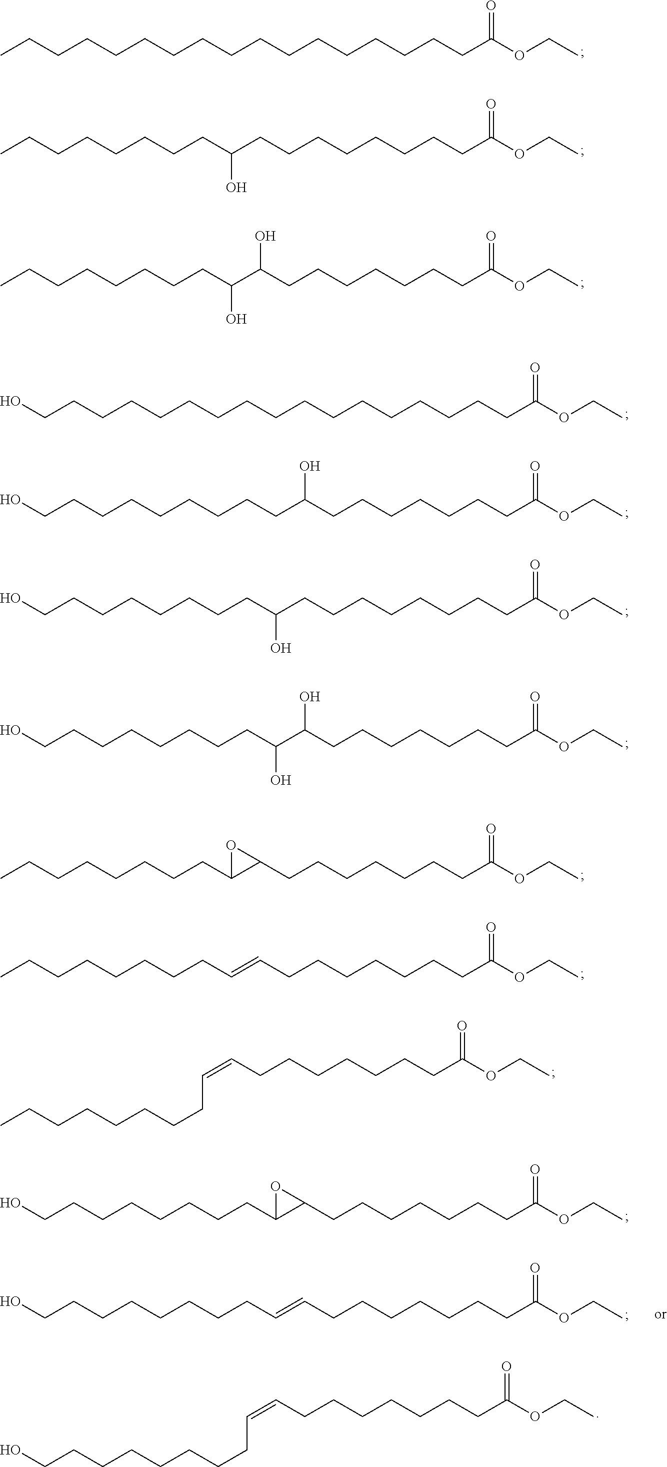

Any of the coating agents used in mixtures herein can include one or more of the following fatty acid 2-glyceryl ester compounds:

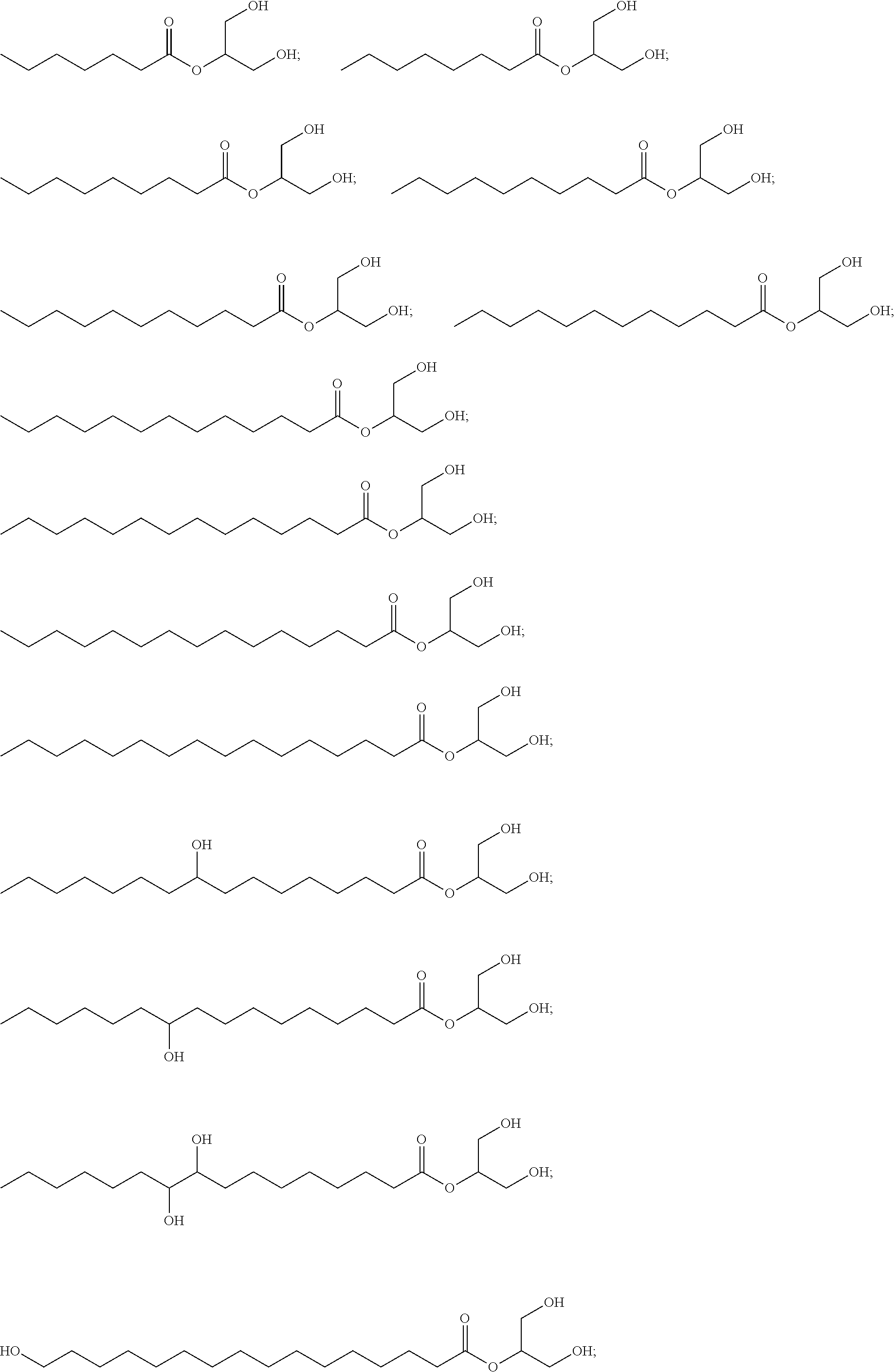

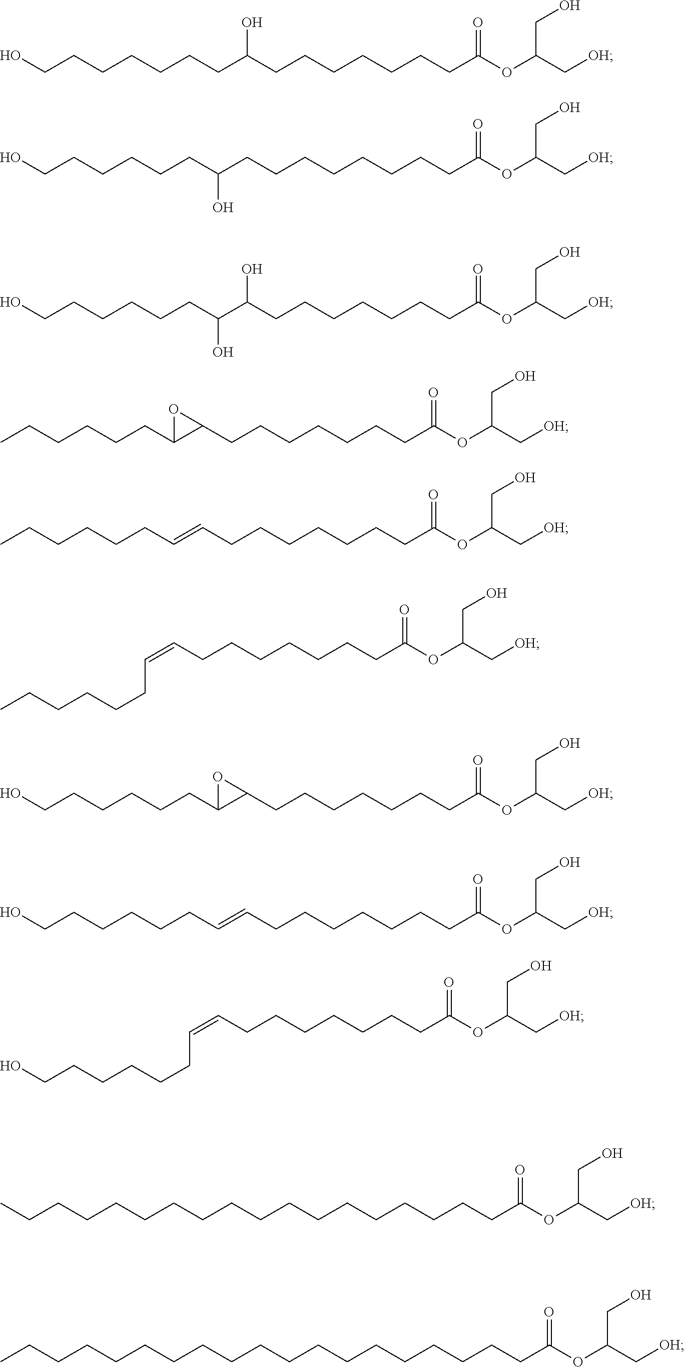

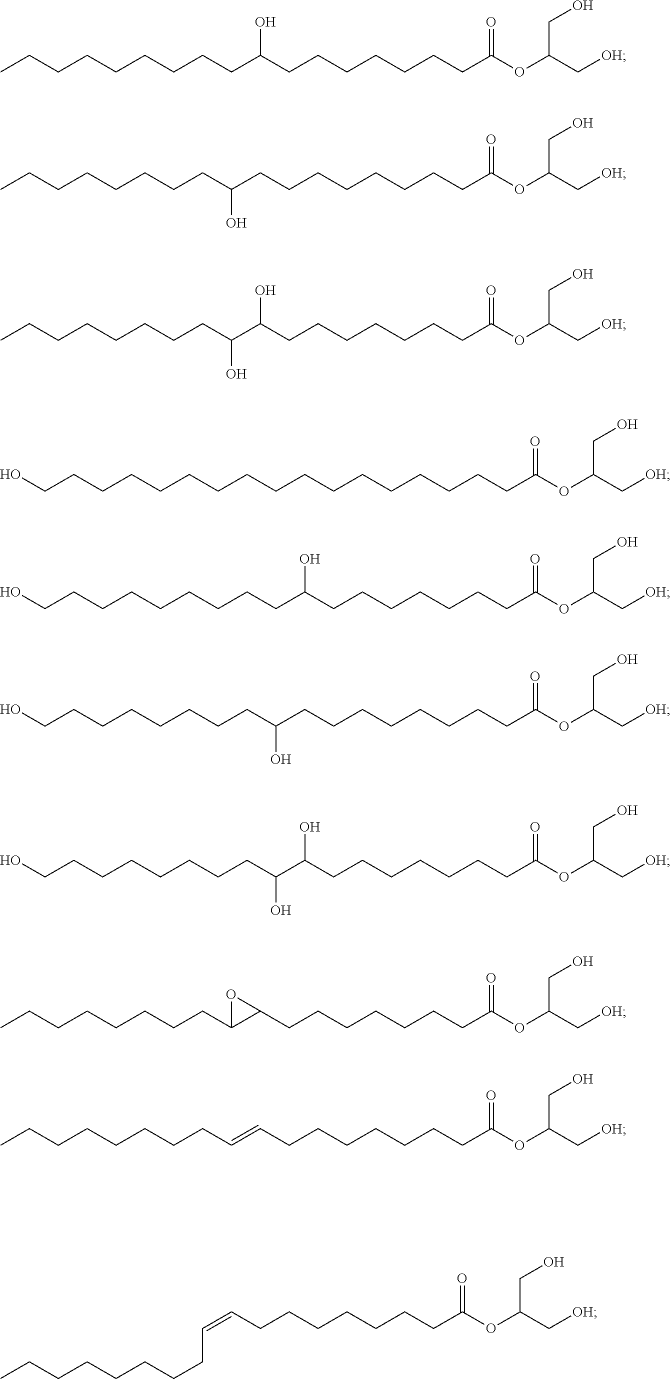

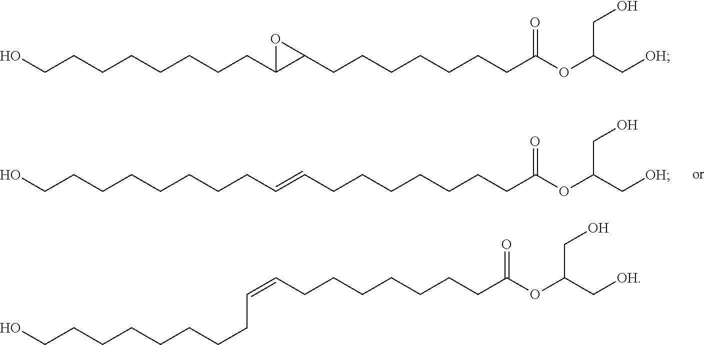

Any of the coating agents used in mixtures herein can include one or more of the following fatty acid 1-glyceryl ester compounds:

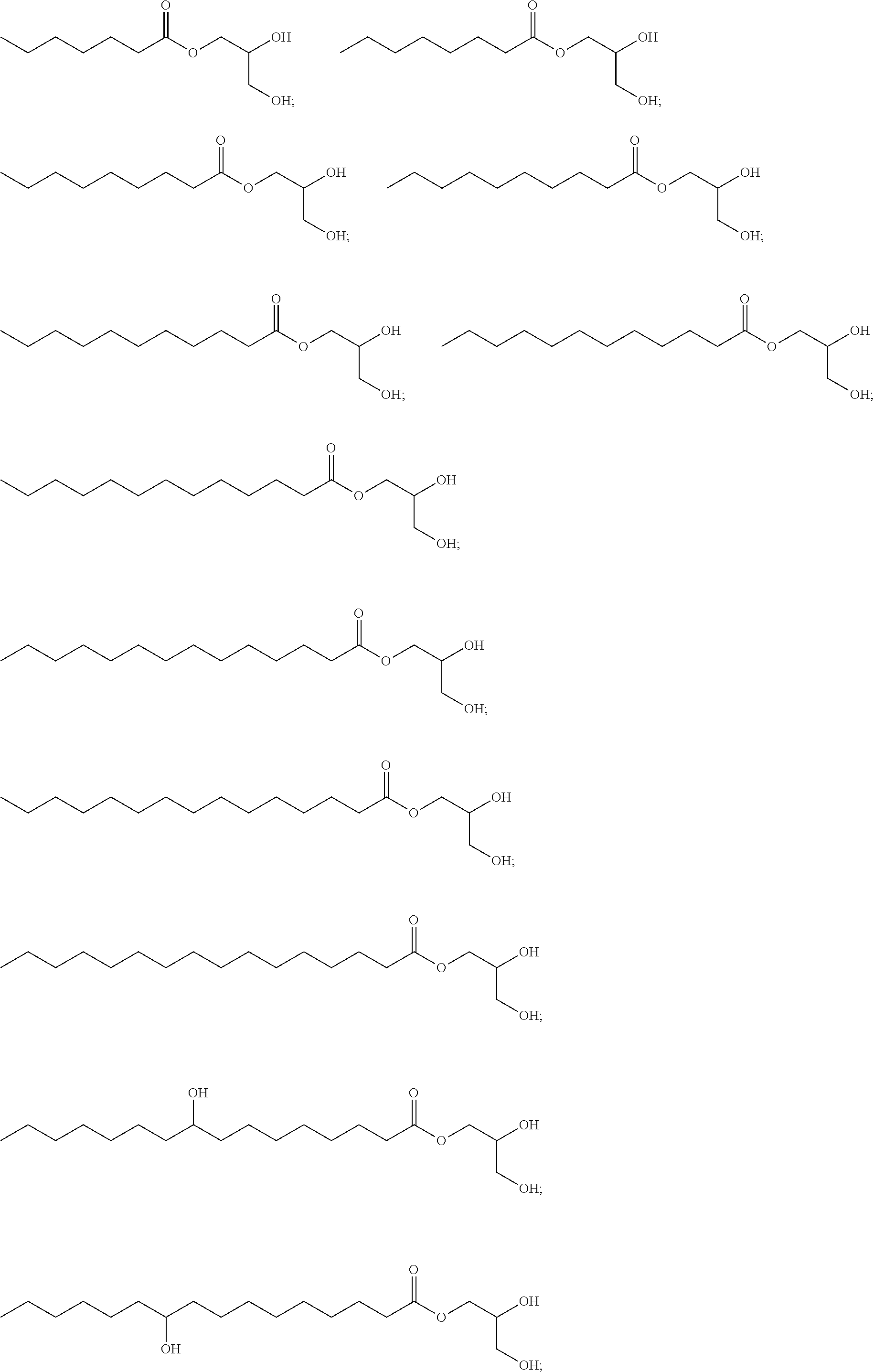

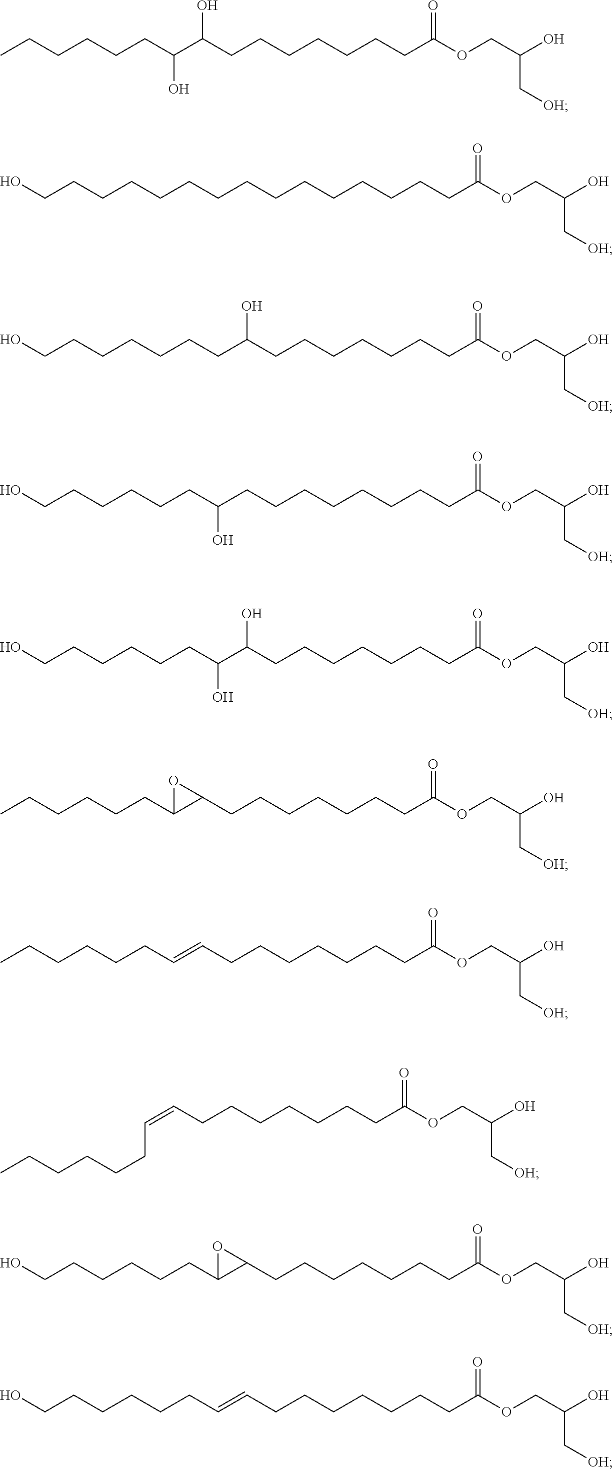

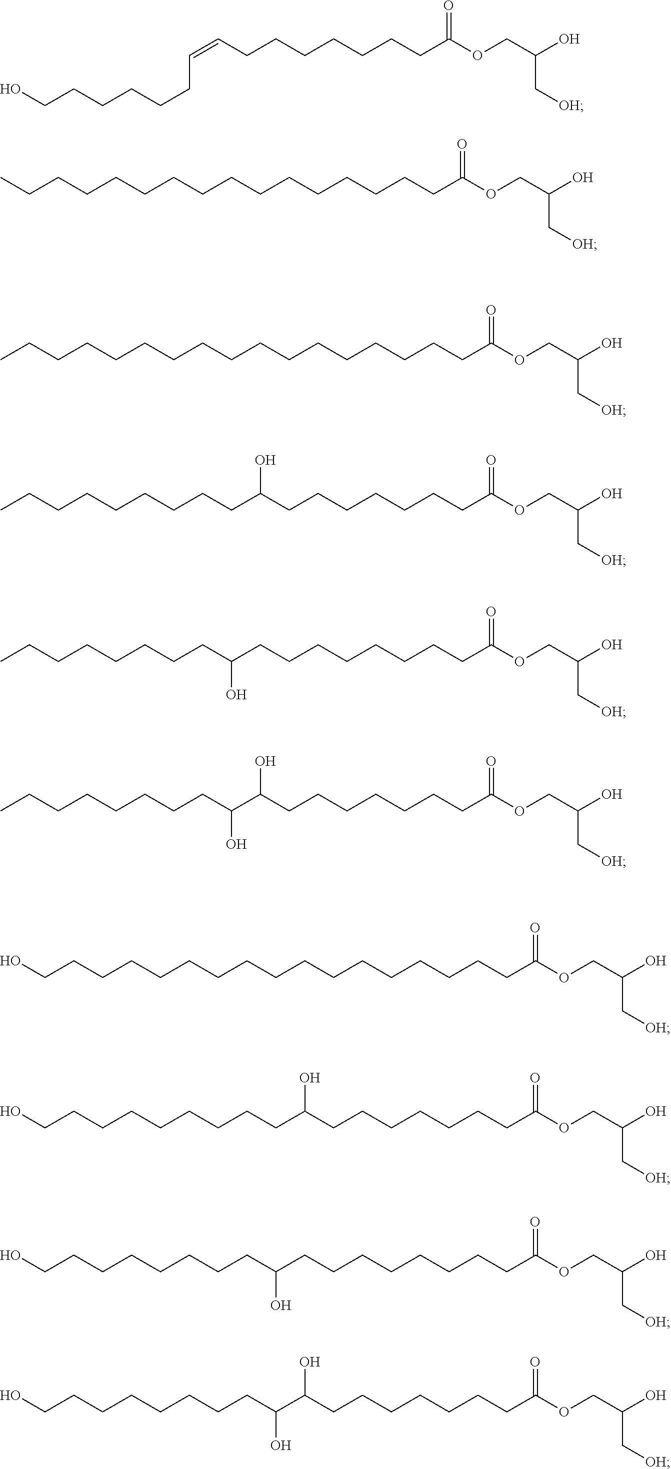

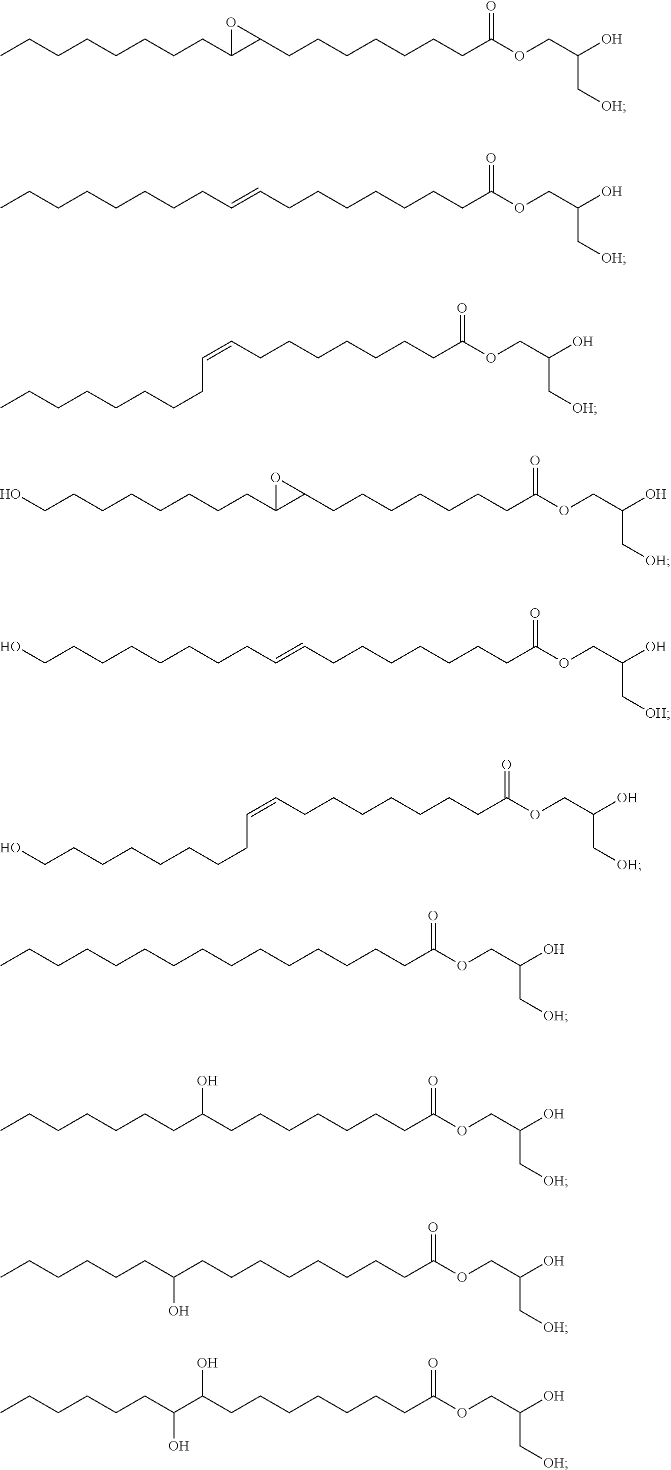

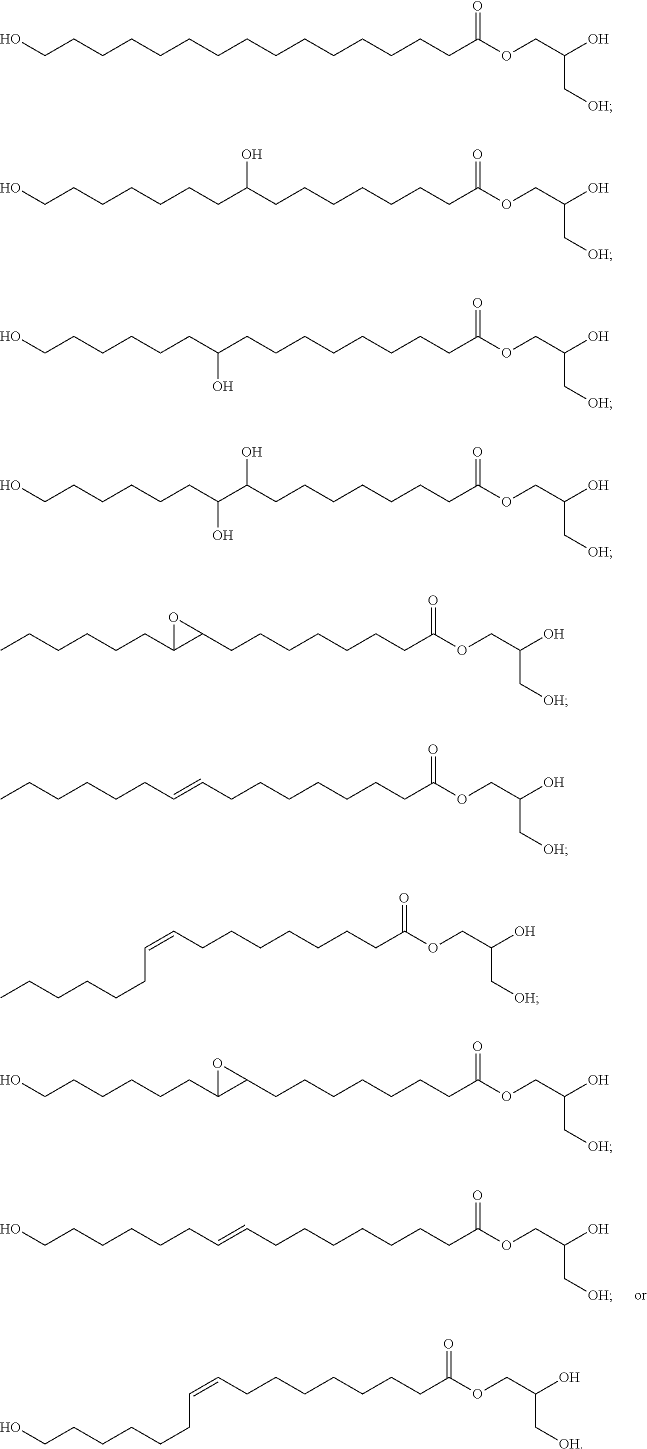

The coating agents herein can include one or more of the following fatty acid salts, where X is a cationic counter ion and n represents the charge state (i.e., the number of proton-equivalent charges) of the cationic counter ion:

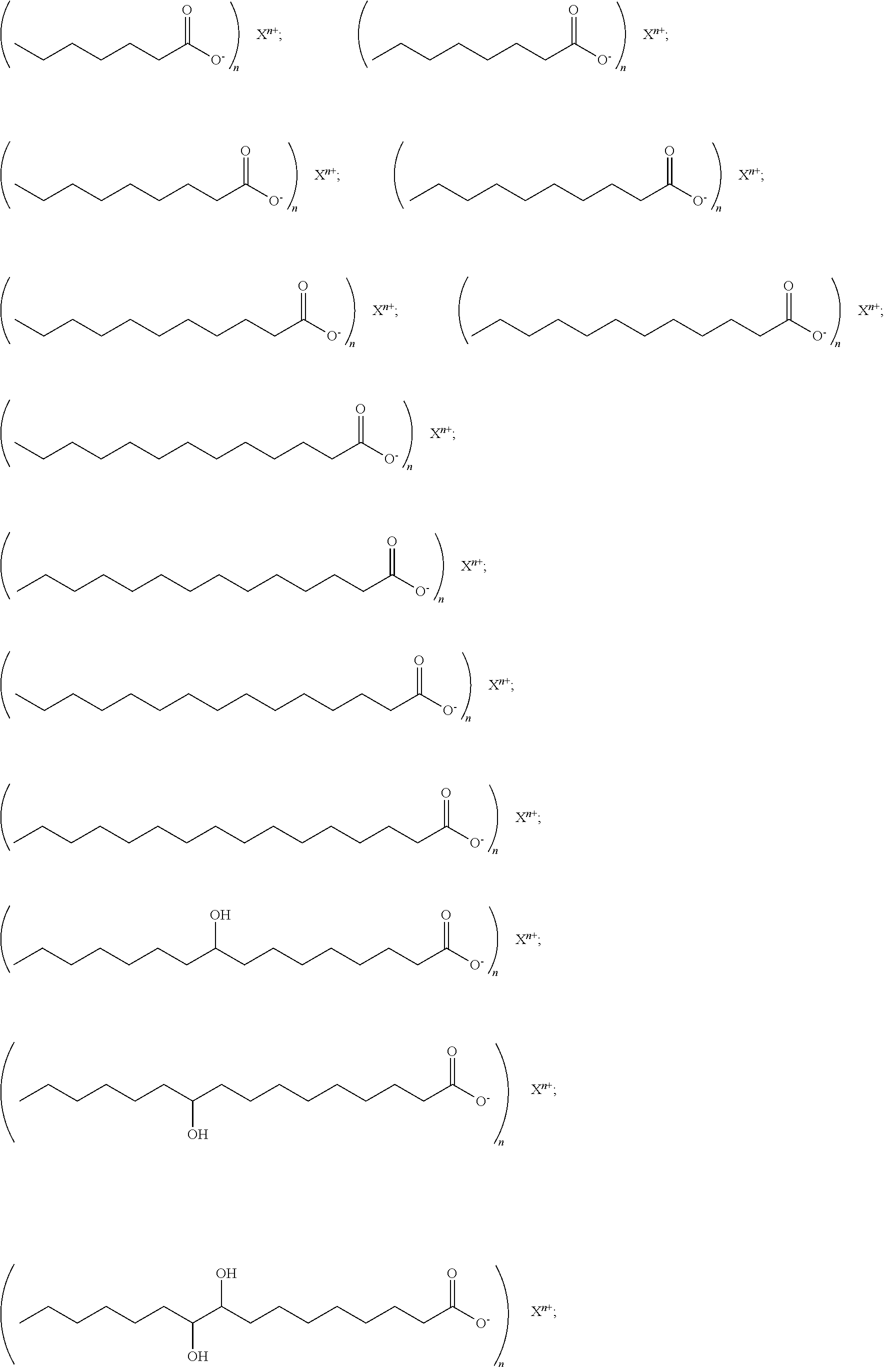

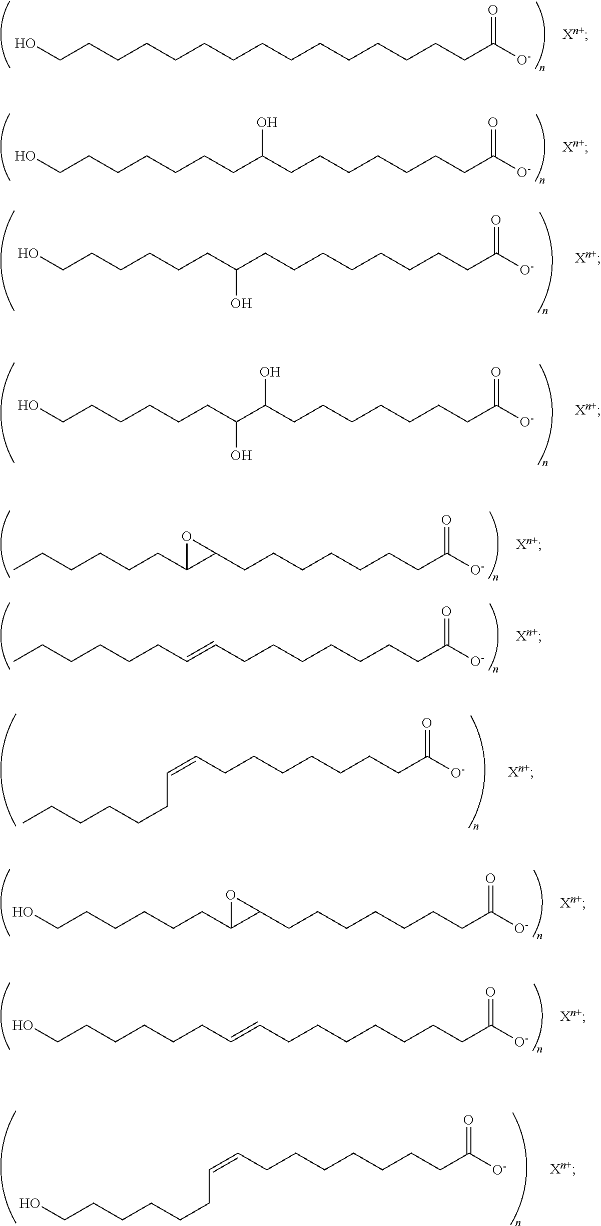

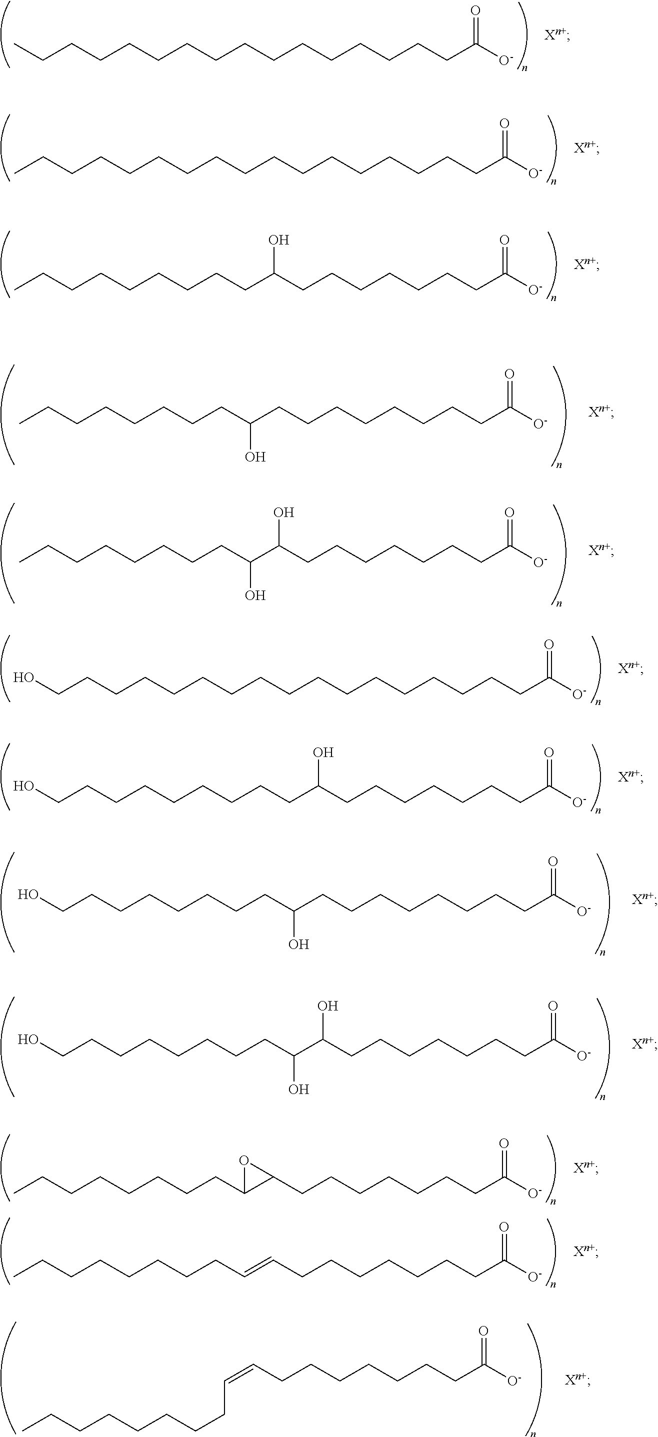

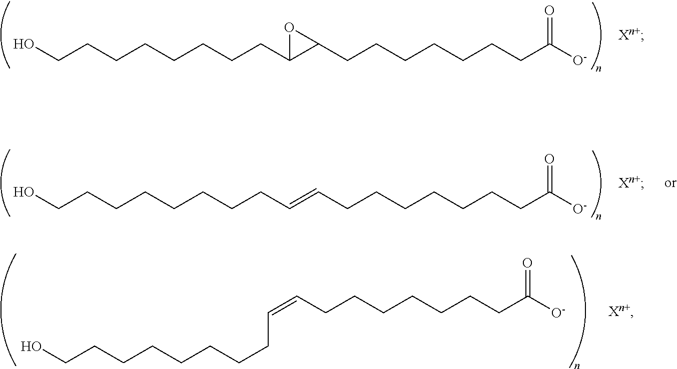

where in some embodiments n is 1, 2, or 3.

The solvent to which the coating agent is added to form the mixture, e.g., a solution, suspension, emulsion, or colloid, can be any polar, non-polar, protic, or aprotic solvents, including any combinations thereof. Examples of solvents that can be used include water, methanol, ethanol, isopropanol, butanol, acetone, ethyl acetate, chloroform, acetonitrile, tetrahydrofuran, diethyl ether, methyl tert-butyl ether, an alcohol, any other suitable solvent, or a combination thereof. The resulting mixture can be suitable for forming coatings on perishable items such as agricultural products. Depending on the solvent that is used, the solubility limit of the coating agent in the solvent may be lower than desired for particular applications. For example, when compounds of Formula I are used as the coating agent and the solvent is water (or is predominantly water), the solubility limit of the coating agent may be relatively low. In these cases it may still be possible to add the desired concentration of coating agent to the solvent and form a suspension or colloid.

While a number of the solvents above (particularly water and ethanol) can be safely and effectively used in mixtures that are applied to edible products, such as produce or other agricultural products, in many cases it can be advantageous to use either water or otherwise a solvent which is at least about 40% (and in many cases higher) water by volume. This is because water is typically less expensive than other suitable solvents and can also be safer to work with than solvents that have a higher volatility and/or a lower flash point (e.g., acetone or alcohols such as isopropanol or ethanol). Accordingly, for any of the mixtures described herein, the solvent or mixture can be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by mass or by volume. In some implementations, the solvent includes a combination of water and ethanol, and can optionally be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by volume. In some implementations, the solvent or mixture can be about 40% to 100% water by mass or volume, about 40% to 99% water by mass or volume, about 40% to 95% water by mass or volume, about 40% to 90% water by mass or volume, about 40% to 85% water by mass or volume, about 40% to 80% water by mass or volume, about 50% to 100% water by mass or volume, about 50% to 99% water by mass or volume, about 50% to 95% water by mass or volume, about 50% to 90% water by mass or volume, about 50% to 85% water by mass or volume, about 50% to 80% water by mass or volume, about 60% to 100% water by mass or volume, about 60% to 99% water by mass or volume, about 60% to 95% water by mass or volume, about 60% to 90% water by mass or volume, about 60% to 85% water by mass or volume, about 60% to 80% water by mass or volume, about 70% to 100% water by mass or volume, about 70% to 99% water by mass or volume, about 70% to 95% water by mass or volume, about 70% to 90% water by mass or volume, about 70% to 85% water by mass or volume, about 80% to 100% water by mass or volume, about 80% to 99% water by mass or volume, about 80% to 97% water by mass or volume, about 80% to 95% water by mass or volume, about 80% to 93% water by mass or volume, about 80% to 90% water by mass or volume, about 85% to 100% water by mass or volume, about 85% to 99% water by mass or volume, about 85% to 97% water by mass or volume, about 85% to 95% water by mass or volume, about 90% to 100% water by mass or volume, about 90% to 99% water by mass or volume, about 90% to 98% water by mass or volume, or about 90% to 97% water by mass or volume.

In order to improve the solubility of the coating agent in the solvent, or to allow the coating agent to be suspended or dispersed in the solvent, the coating agent can further include an emulsifier. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating or the ability of the edible product to be consumed.

In some embodiments, organic salts (e.g., compounds of Formula I where R is a cationic moiety) are added to the coating agent to increase the solubility of the coating agent or allow the coating agent to be suspended or dispersed in solvents having a substantial water content (e.g., solvents that are at least 50% water by volume), provided that the concentration of the salts is not too low (relative to the concentration of compounds of Formula I). Furthermore, the added salts should not substantially degrade the performance of subsequently formed coatings provided that the concentration of the salts (relative to the concentration of the compounds of Formula I) is not too high.

The concentration of the coating agent in the mixture, e.g., solvent, solution, suspension, colloid, or emulsion, can, for example, be in a range of about 1 mg/mL to about 200 mg/mL, such as about 1 to 150 mg/mL, 1 to 100 mg/mL, 1 to 90 mg/mL, 1 to 80 mg/mL, 1 to 75 mg/mL, 1 to 70 mg/mL, 1 to 65 mg/mL, 1 to 60 mg/mL, 1 to 55 mg/mL, 1 to 50 mg/mL, 1 to 45 mg/mL, 1 to 40 mg/mL, 2 to 200 mg/mL, 2 to 150 mg/mL, 2 to 100 mg/mL, 2 to 90 mg/mL, 2 to 80 mg/mL, 2 to 75 mg/mL, 2 to 70 mg/mL, 2 to 65 mg/mL, 2 to 60 mg/mL, 2 to 55 mg/mL, 2 to 50 mg/mL, 2 to 45 mg/mL, 2 to 40 mg/mL, 5 to 200 mg/mL, 5 to 150 mg/mL, 5 to 100 mg/mL, 5 to 90 mg/mL, 5 to 80 mg/mL, 5 to 75 mg/mL, 5 to 70 mg/mL, 5 to 65 mg/mL, 5 to 60 mg/mL, 5 to 55 mg/mL, 5 to 50 mg/mL, 5 to 45 mg/mL, 5 to 40 mg/mL, 10 to 200 mg/mL, 10 to 150 mg/mL, 10 to 100 mg/mL, 10 to 90 mg/mL, 10 to 80 mg/mL, 10 to 75 mg/mL, 10 to 70 mg/mL, 10 to 65 mg/mL, 10 to 60 mg/mL, 10 to 55 mg/mL, 10 to 50 mg/mL, 10 to 45 mg/mL, or 10 to 40 mg/mL.

Any of the mixtures described herein can further include an antimicrobial agent, for example ethanol or citric acid. In some implementations, the antimicrobial agent is part of or a component of the solvent. Any of the mixtures described herein can further include other components or additives such as sodium bicarbonate.

In some implementations, coatings formed from coating agents described herein over agricultural products can be configured to change the surface energy of the agricultural product. Various properties of coatings described herein can be adjusted by tuning the crosslink density of the coating, its thickness, or its chemical composition. This can, for example, be used to control the ripening of postharvest fruit or produce. For example, coatings formed from coating agents that primarily include bifunctional or polyfunctional monomer units can, for example, have higher crosslink densities than those that include monofunctional monomer units. Thus, coatings formed from bifunctional or polyfunctional monomer units can in some cases result in slower rates of ripening as compared to coatings formed from monofunctional monomer units.

Any of the coating agents described herein can further include additional materials that are also transported to the surface with the coating-containing fogs, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some implementations, the mixture that the coating is derived from can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some implementations, the additive can reduce or increase the melting temperature or the glass-transition temperature of the coating. In some implementations, the additive is configured to reduce the diffusivity of water vapor, oxygen, CO₂, or ethylene through the coating or enable the coating to absorb more ultra violet (UV) light, for example to protect the agricultural product (or any of the other products described herein). In some implementations, the additive can be configured to provide an intentional odor, for example a fragrance (e.g., smell of flowers, fruits, plants, freshness, scents, etc.). In some implementations, the additive can be configured to provide color and can include, for example, a dye or a US Food and Drug Administration (FDA) approved color additive.

Any of the coating agents or coatings formed thereof that are described herein can be flavorless or have high flavor thresholds, e.g. above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

The compositions of coating agents described herein can be of high purity. For example, the compositions can be substantially free (e.g., be less than 10% by mass, less than 9% by mass, less than 8% by mass, less than 7% by mass, less than 6% by mass, or less than 5%, 4%, 3%, 2%, or 1% by mass) of diglycerides, triglycerides, proteins, polysaccharides, phenols, lignans, aromatic acids, terpenoids, flavonoids, carotenoids, alkaloids, alcohols, alkanes, and/or aldehydes. In some embodiments, the coating agents comprise less than 10% (e.g., less than 9%, 8%, 7%, 6%, 5%, 4%, 3%, 2%, or 1%) by mass of diglycerides. In some embodiments, the coating agents comprise less than 10% (e.g., less than 9%, 8%, 7%, 6%, 5%, 4%, 3%, 2%, or 1%) by mass of triglycerides.

In some implementations, the deposited coating can have a thickness of less than about 1500 nm, such that the coating is transparent to the naked eye. For example, the deposited coating can have a thickness of about 10 nm, about 20 nm, about 30 nm, about 40 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, 1,000 nm, about 1,100 nm, about 1,200 nm, about 1,300 nm, about 1,400 nm, or about 1,500 nm, inclusive of all ranges therebetween. The coatings can also be thick enough to at least partially protect the substrate or to provide a sufficient barrier to the transfer of water, oxygen, and/or other gases to provide that protection. For example, the protective coating can have a thickness of at least about 10 nm, about 20 nm, about 30 nm, about 40 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm.

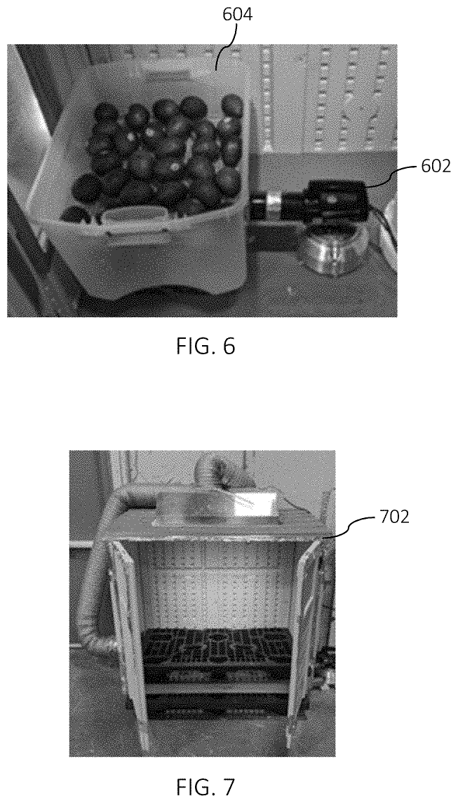

FIG. 6 is a photograph of a fogger 602 configured to apply a fog to avocados inside a container 604. The nozzle of the fogger is adjacent to a hole on the side of container 604, such that the fog generated by the fogger 602 is injected into the container 604 through the hole. During operation, a lid (not shown) is fastened over the top of the container so that the injected fog fills the container and diffuses through the openings between adjacent avocados. In the configuration shown in FIG. 6, the fog stream entering the container is not directly incident on the avocados; the avocados are placed above the stream of injected fog. However, in some applications it may be preferable to place the substrates directly in line with or below the stream of injected fog.

FIG. 7 is a photograph of chamber 702 that can be filled with produce or other substrates to be coated, and then coated via the fogging techniques described herein. Once the substrates are loaded into the chamber 702, the doors are closed, and a fog is injected (e.g., using the fogger 602 in FIG. 6) into the chamber, for example through a hole (not shown) in the side of the chamber. In some implementations, multiple substrates are packed into containers (e.g., container 604 in FIG. 6, or other modified atmospheric packaging) having one or more openings, and the containers are loaded into chamber 702. The fog injected into chamber 702 then diffuses through the holes in the containers so that the fog can be applied to the substrates inside the containers in order to form a coating on the substrates.

### EXEMPLARY EMBODIMENTS

Some exemplary embodiments of this disclosure include:

1. A method of forming a protective coating on a surface of a substrate, comprising:

forming a fog comprising droplets of a mixture, the mixture comprising a coating agent in a solvent;

causing the fog to contact at least a portion of the surface of the substrate so that a portion of the mixture accumulates on at least a portion of the surface of the substrate; and

at least partially removing the solvent from the mixture on the surface of the substrate, thereby forming a protective coating from the coating agent on at least a portion of the surface of the substrate.

2. The method of embodiment 1, wherein the substrate is perishable.
3. The method of embodiment 1, wherein the substrate is selected from a plant or a plant comprising pre-harvested produce.
4. The method of embodiment 1, wherein the substrate comprises produce.
5. The method of embodiment 1, wherein the substrate is maintained within the fog for less than 2 minutes.
6. A method of forming a protective coating on a surface of a substrate, comprising:

forming a first fog comprising droplets of a first mixture, the first mixture comprising a first coating agent in a first solvent;

causing the first fog to contact at least a portion of the surface of the substrate so that a portion of the first mixture accumulates on at least a portion of the surface of the substrate;

at least partially removing the first solvent from the first mixture on the surface of the substrate, thereby forming a first protective coating from the first coating agent on at least part of the surface of the substrate;

forming a second fog comprising droplets of a second mixture, the second mixture comprising a second coating agent in a second solvent;

causing the second fog to contact at least a portion of one or both of the first protective coating on the surface of the substrate or at least a portion of the surface of the substrate that was incompletely coated with the first protective coating so that a portion of the second mixture accumulates on one or both of the first protective coating on the surface of the substrate or at least a portion of the surface of the substrate that was incompletely coated with the first protective coating; and

at least partially removing the second solvent from the second mixture on one or both of the first protective coating on the surface of the substrate or the surface of the substrate that was incompletely coated with the first protective coating, thereby forming a second protective coating from the second coating agent on at least part of one or both of the first protective coating on the surface of the substrate or the surface of the substrate that was incompletely coated with the first protective coating.

7. The method of embodiment 6, wherein the first mixture is the same as the second mixture.
8. The method of embodiment 6, wherein the first mixture is different from the second mixture.
9. The method of embodiment 6, wherein the first fog is applied to the substrate for about the same amount of time as the second fog.
10. The method of embodiment 6, wherein the first fog is applied to the substrate for a different amount of time than the second fog.
11. A method of forming a protective coating on the surfaces of a plurality of items in a container, comprising:

causing a fog comprising droplets of a mixture to enter the container through one or more openings in the container, the mixture comprising a coating agent in a solvent; wherein

the fog disperses through the interior of the container to contact the surface of the plurality of items so that a portion of the mixture accumulates on at least a portion of the surfaces of the plurality of items, thereby causing a protective coating to be formed from the coating agent on at least a portion of the surfaces of the plurality of items.

12. The method of embodiment 11, wherein the items are perishable.
13. The method of embodiment 11, wherein the items comprise produce.
14. The method of embodiment 11, wherein the items are maintained within the fog for less than 2 minutes.
15. The method of embodiment 11, wherein causing the protective coating to be formed from the coating agent on at least a portion of the surfaces of the plurality of items comprises at least partially removing the solvent from the mixture on the surfaces of the plurality of items.
16. The method of embodiment 11, wherein causing the protective coating to be formed from the coating agent on at least a portion of the surfaces of the plurality of items comprises cooling or drying the plurality of items via convection through at least one of the openings in the container.
17. A method of forming a protective coating on the surfaces of a plurality of items, comprising:

forming a fog in an enclosure, the fog comprising droplets of a mixture, the mixture comprising a coating agent in a solvent;

after at least partially forming the fog, moving the plurality of items into the enclosure, thereby causing the fog to contact at least a portion of the surface of the plurality of items so that a portion of the mixture accumulates on at least a portion of the surfaces of the plurality of items; and

causing the solvent to be at least partially removed from the mixture on the surface of the plurality of items, thereby forming the protective coating from the coating agent on at least a portion of the surface of the plurality of items.

18. The method of embodiment 17, wherein the items are perishable.
19. The method of embodiment 17, wherein the items comprise produce.
20. The method of embodiment 17, wherein the items are maintained within the fog for less than 2 minutes.
21. A method of forming a protective coating on the surface of pre-harvested produce, comprising:

forming a fog comprising droplets of a mixture, the mixture comprising a coating agent in a solvent; and

causing the fog to contact at least a portion of the outer surface of the pre-harvested produce so that a portion of the mixture accumulates on at least a portion of the outer surface of the pre-harvested produce, thereby causing a protective coating to be formed from the coating agent on at least a portion of the outer surface of the pre-harvested produce; wherein

the fog disperses through openings around the pre-harvested produce to improve coverage of the protective coating on the outer surfaces of the pre-harvested produce.

22. The method of embodiment 21, wherein the pre-harvested produce is maintained within the fog for less than 2 minutes.
23. The method of embodiment 21, wherein causing the protective coating to be formed comprises at least partially removing the solvent from the mixture on at least a portion of the outer surface of the pre-harvested produce.
24. The method of any of embodiments 1-23, wherein the fog is formed by a method comprising:

(i) heating the mixture to form a vapor; and

(ii) cooling the vapor to form the fog comprising droplets of the mixture.

25. The method of embodiment 24, wherein the droplets of the fog have an average diameter of about 100 microns or smaller.
26. The method of embodiment 24, wherein heating the mixture comprises passing the mixture through a heat exchanger that is held at a temperature of at least 150° C.
27. A method of forming a protective coating on a surface of a substrate, comprising: heating a mixture to form a vapor, wherein the mixture comprises a coating agent in a solvent;

cooling the vapor to form a fog comprising droplets of the mixture; and

causing the fog to contact the surface of the substrate so that a portion of the mixture accumulates on at least a portion of the surface of the substrate, thereby causing a protective coating to be formed from the coating agent on at least a part of the surface of the substrate.

28. The method of embodiment 27, wherein the substrate is maintained within the fog for less than 2 minutes.
29. The method of embodiment 27, wherein causing the protective coating to be formed comprises at least partially removing the solvent from the mixture on the surface of the substrate.
30. The method of any of embodiments 1-23 or 27-29, wherein the droplets have an average diameter of about 100 microns or smaller.
31. The method of any of embodiments 1-10, 15, 17-19, 23, or 29, wherein the at least partially removing the solvent comprises allowing the solvent to evaporate.
32. The method of embodiment 31, wherein at least 95% of the solvent evaporates after 30 minutes or less.
33. The method of any of embodiments 1-23 or 27-29, wherein the protective coating is at least 0.1 microns thick.
34. The method of any of embodiments 1-23 or 27-29, wherein the protective coating is edible.
35. The method of any of embodiments 1-23 or 27-29, wherein the solvent comprises water or ethanol.
36. The method of any of embodiments 1-23 or 27-29, wherein the coating agent comprises monomers, oligomers, fatty acids, esters, amides, amines, thiols, carboxylic acids, ethers, aliphatic waxes, alcohols, or salts.
37. The method of any of embodiments 1-23 or 27-29, wherein the coating agent comprises a compound of Formula I, wherein Formula I is:

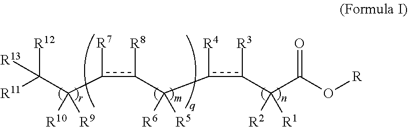

wherein:

R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

38. An assembly for applying a protective coating on a substrate, comprising:

a reservoir having a mixture therein, the mixture comprising a coating agent in a solvent;

a heat exchanger; and

a pump configured to force the mixture through the heat exchanger; wherein

the heat exchanger is capable of being heated to a sufficiently high temperature to cause the mixture to become a vapor as it is forced through the heat exchanger.

39. The assembly of embodiment 38, further comprising a nozzle, wherein the assembly is configured such that the vapor becomes a fog as it exits the nozzle, and wherein droplets of the fog comprise the mixture.
40. The assembly of any of embodiments 38-39, wherein the coating agent comprises monomers, oligomers, fatty acids, esters, amides, amines, thiols, carboxylic acids, ethers, aliphatic waxes, alcohols, or salts.
41. The assembly of embodiment 40, wherein the solvent comprises water, ethanol, or a combination thereof.
42. The assembly of any of embodiments 38-39, wherein the coating agent comprises a compound of Formula I, wherein Formula I is:

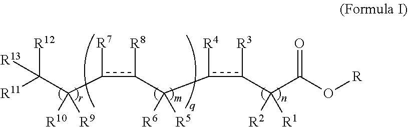

wherein:

R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;

R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;

R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or

R³ and R⁴ can combine with the carbon atoms to which they are attached to form a C₃-C₆ cycloalkyl, a C₄-C₆ cycloalkenyl, or 3- to 6-membered ring heterocycle; and/or

R⁷ and R⁸ can combine with the carbon atoms to which they are attached to form a C₃-C₆ cycloalkyl, a C₄-C₆ cycloalkenyl, or 3- to 6-membered ring heterocycle;

R¹⁴ and R¹⁵ are each independently, at each occurrence, —H, aryl, heteroaryl, —C₁-C₆ alkyl, —C₂-C₆ alkenyl, or —C₂-C₆ alkynyl;

the symbol [symbol] represents a single bond or a cis or trans double bond;

n is 0, 1, 2, 3, 4, 5, 6, 7 or 8;

m is 0, 1, 2 or 3;

q is 0, 1, 2, 3, 4 or 5; and

r is 0, 1, 2, 3, 4, 5, 6, 7 or 8.

43. The assembly of embodiment 42, wherein the solvent comprises water, ethanol, or a combination thereof.

### EXAMPLES

The following examples compare mass loss rates of coated and uncoated strawberries using the processes disclosed herein. These examples are only for illustrative purposes and are not meant to limit the scope of the present disclosure. In each of the examples, the coatings were formed by fogging the strawberries with a mixture and then allowing the solvent from the mixture to evaporate under ambient conditions. The mixture for each coating was prepared by adding 50 mg/mL of a coating agent to water to form a suspension, where the coating agent includes SA-1G and SA-Na mixed at a 94:6 mass ratio. A Burgess Professional 982 Thermo-Fogger (Fogger 602 pictured in FIG. 6) was used to generate the fog from the mixture. To form the fog, the mixture was placed in the reservoir of the fogger, the barrel temperature was set to its default value, and the flow rate was adjusted to a value such that a fog (and not a spray) was emitted through the nozzle of the fogger.

### Example 1: Mass Loss Rate of Strawberries Coated by Fogging and Stored in Ambient Conditions

12 conventional strawberry clamshells (storage containers), each having a volume of about 3 L, were filled with strawberries (approximately 55 strawberries per clamshell). The strawberry filled clamshells were split into 4 groups of 3 clamshells per group. The clamshells of the first group were untreated (control group). The clamshells of the second group were each sequentially treated as follows. The clamshell was placed in the 68 L container 604 shown in FIG. 6, and the container was filled with fog emitted by the fogger through a hole in the side of the chamber for 90 seconds, similar to the set-up for avocados illustrated in FIG. 6. As with the avocados in FIG. 6, the strawberry filled clamshell was not placed in line with the stream of fog injected into the container. As such, as the fog filled the container, the droplets diffused through the holes in the clamshell and between adjacent strawberries to contact exposed surfaces of the strawberries. The clamshell was then removed from the chamber, and the strawberries were dried in ambient conditions (temperature in the range of about 23° C.-27° C. and humidity in the range of about 40%-55%) for about 10 minutes without opening the lid of the clamshell or removing the strawberries from the clamshell. The clamshells of the third group were treated similarly to those of the second group, except that 2 layers of fog were applied to each clamshell. That is, after applying the first layer of fog to each strawberry filled clamshell and drying in ambient conditions for 10 minutes, the clamshell was returned to the 68 L container and fogged a second time under the same conditions, and then allowed to dry again in ambient conditions for 10 minutes. The clamshells of the fourth group were treated similarly to those of the first and second groups, except that 3 layers of fog were applied to each clamshell of the fourth group using the same procedures described above.

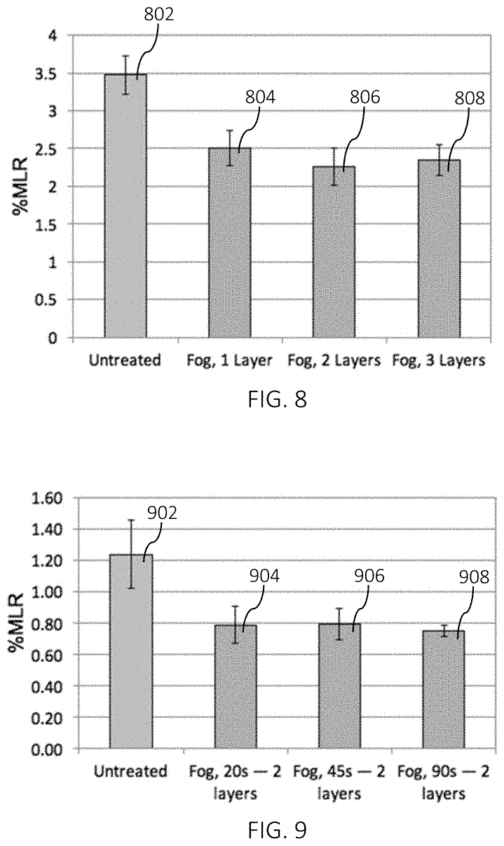

The four groups of strawberries were then kept in their respective clamshells and stored in ambient conditions, and average mass loss rates of each of the groups of strawberries were measured by weighing the strawberry filled clamshells at various time intervals. The average mass loss rates of each of the groups of strawberries are shown in FIG. 8, where bar 802 corresponds to the first group of strawberries (untreated), bar 804 corresponds to the second group of strawberries (treated with 1 layer of fog), bar 806 corresponds to the third group of strawberries (treated with 2 layers of fog), and bar 808 corresponds to the fourth group of strawberries (treated with 3 layers of fog). As shown, the untreated strawberries (bar 802) exhibited a mass loss rate of about 3.5%, the strawberries treated with 1 layer of fog (bar 804) exhibited a mass loss rate of about 2.5%, the strawberries treated with 2 layers of fog (bar 806) exhibited a mass loss rate of about 2.3%, and the strawberries treated with 3 layers of fog (bar 808) exhibited a mass loss rate of about 2.4%.

### Example 2: Mass Loss Rate of Strawberries Coated by Fogging and Stored in Cold Storage Conditions

12 conventional strawberry clamshells (storage containers), each having a volume of about 3 L, were filled with strawberries (approximately 55 strawberries per clamshell). The strawberry filled clamshells were split into 4 groups of 3 clamshells per group. The clamshells of the first group were untreated (control group). The clamshells of the second group were each treated with 2 layers of fog using the same procedures as those corresponding to the third group (bar 806) in the previous example, except that the fogging time for each layer was 20 seconds. The clamshells of the third group were treated with 2 layers of fog using the same procedures as those corresponding to the second group, except that the fogging time for each layer was 45 seconds. The clamshells of the fourth group were treated with 2 layers of fog using the same procedures as those corresponding to the second and third groups, except that the fogging time for each layer was 90 seconds.

The four groups of strawberries were then kept in their respective clamshells and stored in cold storage conditions at a temperature of 4° C. and 90% relative humidity, and average mass loss rates of each of the groups of strawberries were measured by weighing the strawberry filled clamshells at various time intervals. The average mass loss rates of each of the groups of strawberries are shown in FIG. 9, where bar 902 corresponds to the first group of strawberries (untreated), bar 904 corresponds to the second group of strawberries (2 layers of fog, 20 second fog time per layer), bar 906 corresponds to the third group of strawberries (2 layers of fog, 45 second fog time per layer), and bar 908 corresponds to the fourth group of strawberries (2 layers of fog, 90 second fog time per layer). As shown, the untreated strawberries (bar 902) exhibited a mass loss rate of about 1.24%, the strawberries treated with 2 layers of fog, 20 second fog time per layer (bar 904) exhibited a mass loss rate of about 0.79%, the strawberries treated with 2 layers of fog, 45 second fog time per layer (bar 906) exhibited a mass loss rate of about 0.80%, and the strawberries treated with 2 layers of fog, 90 second fog time per layer (bar 908) exhibited a mass loss rate of about 0.76%.

Various implementations of fogging systems and associated methods of use have been described. However, it should be understood that they have been presented by way of example only, and that various changes in form and details may be made. For example, fogging systems described herein can also be used to treat (e.g., coat) other types of substrates, such as meat, poultry, plants, textiles/clothing material, pharmaceuticals, medical equipment, or other substrates, including edible and non-edible substrates. Where methods and steps described above indicate certain events occurring in certain order, those of ordinary skill in the art having the benefit of this disclosure would recognize that the ordering of certain steps may be modified and such modification are in accordance with the variations of the disclosure. Accordingly, other implementations are within the scope of the following claims.

1. A method of forming a protective coating on a surface of a substrate, comprising:
forming a fog comprising droplets of a mixture, the mixture comprising a coating agent in a solvent;
causing the fog to contact at least a portion of the surface of the substrate so that a portion of the mixture accumulates on at least a portion of the surface of the substrate; and
at least partially removing the solvent from the mixture on the surface of the substrate, thereby forming a protective coating from the coating agent on at least a portion of the surface of the substrate.

2. The method of claim 1, wherein the fog is formed by a method comprising:
(i) heating the mixture to form a vapor; and
(ii) cooling the vapor to form the fog comprising droplets of the mixture.

3. The method of claim 1, wherein the substrate is perishable.

4. The method of claim 1, wherein the substrate is selected from a plant or a plant comprising pre-harvested produce.

5. The method of claim 1, wherein the substrate comprises produce.

6. The method of claim 1, wherein the substrate is maintained within the fog for less than 2 minutes.

7. The method of any of claim 1, wherein the coating agent comprises a compound of Formula I, wherein Formula I is: 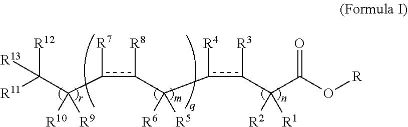
wherein:
R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.

8. A method of forming a protective coating on a surface of a substrate, comprising:
forming a first fog comprising droplets of a first mixture, the first mixture comprising a first coating agent in a first solvent;
causing the first fog to contact at least a portion of the surface of the substrate so that a portion of the first mixture accumulates on at least a portion of the surface of the substrate;
at least partially removing the first solvent from the first mixture on the surface of the substrate, thereby forming a first protective coating from the first coating agent on at least part of the surface of the substrate;
forming a second fog comprising droplets of a second mixture, the second mixture comprising a second coating agent in a second solvent;
causing the second fog to contact at least a portion of one or both of the first protective coating on the surface of the substrate or at least a portion of the surface of the substrate that was incompletely coated with the first protective coating so that a portion of the second mixture accumulates on one or both of the first protective coating on the surface of the substrate or at least a portion of the surface of the substrate that was incompletely coated with the first protective coating; and
at least partially removing the second solvent from the second mixture on one or both of the first protective coating on the surface of the substrate or the surface of the substrate that was incompletely coated with the first protective coating, thereby forming a second protective coating from the second coating agent on at least part of one or both of the first protective coating on the surface of the substrate or the surface of the substrate that was incompletely coated with the first protective coating.

9. The method of claim 8, wherein the first mixture is the same as the second mixture.

10. The method of claim 8, wherein the first mixture is different from the second mixture.

11. The method of claim 8, wherein the first fog is formed by a method comprising:
(i) heating the first mixture to form a vapor; and
(ii) cooling the vapor to form the first fog comprising droplets of the first mixture.

12. The method of claim 8, wherein the second fog is formed by a method comprising:
(i) heating the second mixture to form a vapor; and
(ii) cooling the vapor to form the second fog comprising droplets of the first mixture.

13. The method of claim 8, wherein the first fog is applied to the substrate for about the same amount of time as the second fog.

14. The method of claim 8, wherein the first fog is applied to the substrate for a different amount of time than the second fog.

15. The method of any of claim 8, wherein the first and second coating agent independently comprise a compound of Formula I, wherein Formula I is: 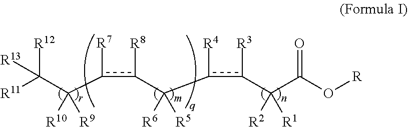
wherein:
R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.

16. A method of forming a protective coating on the surfaces of a plurality of items in a container, comprising:
causing a fog comprising droplets of a mixture to enter the container through one or more openings in the container, the mixture comprising a coating agent in a solvent; wherein
the fog disperses through the interior of the container to contact the surface of the plurality of items so that a portion of the mixture accumulates on at least a portion of the surfaces of the plurality of items, thereby causing a protective coating to be formed from the coating agent on at least a portion of the surfaces of the plurality of items.

17. The method of any of claim 16, wherein the fog is formed by a method comprising:
(i) heating the mixture to form a vapor; and
(ii) cooling the vapor to form the fog comprising droplets of the mixture.

18. The method of claim 16, wherein the items are perishable.

19. The method of claim 16, wherein the items comprise produce.

20. The method of claim 16, wherein the items are maintained within the fog for less than 2 minutes.

21. The method of claim 16, wherein causing the protective coating to be formed from the coating agent on at least a portion of the surfaces of the plurality of items comprises at least partially removing the solvent from the mixture on the surfaces of the plurality of items.

22. The method of claim 16, wherein causing the protective coating to be formed from the coating agent on at least a portion of the surfaces of the plurality of items comprises cooling or drying the plurality of items via convection through at least one of the openings in the container.

23. The method of any of claim 16, wherein the coating agent comprises a compound of Formula I, wherein Formula I is: 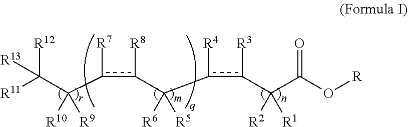
wherein:
R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.

24. A method of forming a protective coating on the surfaces of a plurality of items, comprising:
forming a fog in an enclosure, the fog comprising droplets of a mixture, the mixture comprising a coating agent in a solvent;
after at least partially forming the fog, moving the plurality of items into the enclosure, thereby causing the fog to contact at least a portion of the surface of the plurality of items so that a portion of the mixture accumulates on at least a portion of the surfaces of the plurality of items; and
causing the solvent to be at least partially removed from the mixture on the surface of the plurality of items, thereby forming the protective coating from the coating agent on at least a portion of the surface of the plurality of items.

25. The method of claim 24, wherein the fog is formed by a method comprising:
(i) heating the mixture to form a vapor; and
(ii) cooling the vapor to form the fog comprising droplets of the mixture.

26. The method of claim 24, wherein the items are perishable.

27. The method of claim 24, wherein the items comprise produce.

28. The method of claim 24, wherein the items are maintained within the fog for less than 2 minutes.

29. The method of any of claim 24, wherein the coating agent comprises a compound of Formula I, wherein Formula I is: 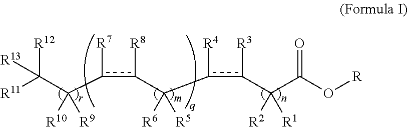
wherein:
R is selected from —H, -glyceryl, —C₁-C₆ alkyl, —C₂-C₆ alkenyl, —C₂-C₆ alkynyl, —C₃-C₇ cycloalkyl, aryl, heteroaryl, or a cationic moiety, wherein each alkyl, alkenyl, alkynyl, cycloalkyl, aryl or heteroaryl is optionally substituted with one or more groups selected from halogen (e.g., Cl, Br, or I), hydroxyl, nitro, —CN, —NH₂, —SH, —SR¹⁵, —OR¹⁴, —NR¹⁴R¹⁵, C₁-C₆ alkyl, C₂-C₆ alkenyl, or C₂-C₆ alkynyl;
R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
R³, R⁴, R⁷, and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl wherein each alkyl, alkynyl, cycloalkyl, aryl, or heteroaryl is optionally substituted with one or more —OR¹⁴, —NR¹⁴R¹⁵, —SR¹⁴, or halogen; or
R³ and R⁴ can combine with the carbon atoms to which they are attached to form a C₃-C₆ cycloalkyl, a C₄-C₆ cycloalkenyl, or 3- to 6-membered ring heterocycle; and/or
R⁷ and R⁸ can combine with the carbon atoms to which they are attached to form a C₃-C₆ cycloalkyl, a C₄-C₆ cycloalkenyl, or 3- to 6-membered ring heterocycle;
R¹⁴ and R¹⁵ are each independently, at each occurrence, —H, aryl, heteroaryl, —C₁-C₆ alkyl, —C₂-C₆ alkenyl, or —C₂-C₆ alkynyl;
the symbol [symbol] represents a single bond or a cis or trans double bond;
n is 0, 1, 2, 3, 4, 5, 6, 7 or 8;
m is 0, 1, 2 or 3;
q is 0, 1, 2, 3, 4 or 5; and
r is 0, 1, 2, 3, 4, 5, 6, 7 or 8.
